(19) United States
(12) Patent Application Publication
(10) Pub. No.: US 2015/0071434 A1
(43) Pub. Date: Mar. 12, 2015

(54) Secure Semiconductor Device Having Features to Prevent Reverse Engineering

(71) Applicant: STATIC CONTROL COMPONENTS, INC., Sanford, NC (US)

(72) Inventors: William Eli Thacker, III, Sanford, NC (US); Robert Francis Tenczar, Fayetteville, NC (US); Michael Clinton Hoke, Raleigh, NC (US)

(73) Assignee: STATIC CONTROL COMPONENTS, INC., Sanford, NC (US)

(21) Appl. No.: 13/838,853

(22) Filed: Mar. 15, 2013

Related U.S. Application Data
(63) Continuation-in-part of application No. 13/739,429, filed on Jan. 11, 2013, now abandoned.
Application No. 13/739,429 is a continuation-in-part of application No. 13/663,921, filed on Oct. 30, 2012.
Application No. 13/663,921 is a division of application No. 13/194,452, filed on Jul. 29, 2011, now abandoned.
(60) Provisional application No. 61/494,172, filed on Jun. 7, 2011.

(51) Int. Cl. H04L 9/30

(52) U.S. Cl. CPC H04L 9/30
USPC 380/30

(57) ABSTRACT

An encryption circuit for receiving an input of a first digital key and plaintext data, the encryption circuit for mathematically manipulating the digital key and the plaintext data to encrypt the plaintext data into encrypted data, wherein at least a portion of the encryption circuit comprises IBG circuitry. A decryption circuit for receiving an input of a second digital key and the encrypted data, the decryption circuit for mathematically manipulating the digital key and the encrypted data to decrypt the encrypted data into the plaintext data, wherein at least a portion of the decryption circuit comprises IBG circuitry

The present application is a continuation-in-part of U.S. patent application Ser. No. 13/739,429 filed on Jan. 11, 2013, which is a continuation-in-part of U.S. patent application Ser. No. 13/194,452 filed on Jul. 29, 2011, which claims the benefit of U.S. Provisional Application Ser. No. 61/494,172 filed Jun. 7, 2011, both of which are incorporated by reference herein in their entirety.

### BACKGROUND

It is desirable to design an electronic chip that is difficult to reverse engineer to protect the circuit design. Known reverse engineering techniques include methods for tearing down layers of the chip to expose the logic devices.

Semiconductor teardown techniques typically involve imaging a device layer, removing the layer, imaging the next layer, removing the layer, and so on until a complete representation of the semiconductor device is realized. Layer imaging is usually accomplished using an optical or electron microscope. Layer removal can be done by using physical means such as lapping or polishing, by chemical means by etching specific compounds, by using a laser or a focused ion beam technique (FIB), or by any other known method capable of removing the layers. FIG. 1 shows some of the semiconductor layers and regions that are imaged by the teardown reverse engineering technique.

Once the semiconductor device teardown is complete and the imaging information is gathered, the logic function of the device can be re-constructed by using diffusion, polysilicon, and well areas to define the MOS devices used to create logic gates, and the metal layers to define how the logic gates are interconnected. FIG. 2 shows how the semiconductor layers define the MOS device.

U.S. Pat. No. 7,711,964 discloses one method of protecting logic configuration data. The configuration data for the logic device is encrypted and a decryption key is encrypted using a silicon key. The encrypted decryption key and configuration are transferred to the logic device. The silicon key is used to decrypt the decryption key which is then used to decrypt the configuration data. One problem with this method is that the chip is not protected against physical reverse engineering as described above.

Many other cryptography techniques are known. But, all cryptographic techniques are vulnerable to the conventional teardown techniques.

Disclosed is a method for designing a semiconductor device that is resistant to these techniques. The semiconductor device includes a physical geometry which is not clearly indicative of the device's function. For example, the semiconductor device is designed where two or more types of logic devices have the same physical geometry. When the teardown method is performed two or more devices will show the same physical geometry, but, these two or more devices have different logic functions. This prevents the person performing the reverse engineering to determine the logic functions by the known methods of observing the geometry of the devices.

Employing the disclosed method and device will force the reverse engineer to employ more difficult techniques. These techniques are more time consuming, more expensive, and more likely to have errors.

### SUMMARY

The present method and device presents a semiconductor device that it is difficult to reverse engineer using known techniques.

In one aspect of the present invention, a security device includes an encryption circuit for receiving an input of a first digital key and plaintext data, the encryption circuit for mathematically manipulating the digital key and the plaintext data to encrypt the plaintext data into encrypted data, wherein at least a portion of the encryption circuit comprises IBG circuitry. In another aspect of the present invention, a security device includes a decryption circuit for receiving an input of a second digital key and the encrypted data, the decryption circuit for mathematically manipulating the digital key and the encrypted data to decrypt the encrypted data into the plaintext data, wherein at least a portion of the decryption circuit comprises IBG circuitry

These and other features and objects of the invention will be more fully understood from the following detailed description of the embodiments, which should be read in light of the accompanying drawings.

In this regard, before explaining at least one embodiment of the invention in detail, it is to be understood that the invention is not limited in its application to the details of construction and to the arrangements of the components set forth in the description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be used as a basis for designing other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The accompanying drawings, which are incorporated in and form a part of the specification, illustrate embodiments of the present invention and, together with the description, serve to explain the principles of the invention;

FIG. 1 illustrates semiconductor layers and regions that are imaged by the teardown reverse engineering technique;

FIG. 2 illustrates how the semiconductor layers define the MOS device;

FIG. 3 illustrates a circuit that is resistive to conventional reverse engineering techniques;

FIG. 4 illustrates a circuit configuration using a comparator;

FIG. 5 illustrates a second configuration using a comparator;

FIG. 6 illustrates a circuit configuration without a comparator;

FIG. 7 illustrates a second circuit configuration without a comparator;

FIG. 8 illustrates an circuit configuration having six active devices;

FIG. 9A illustrates a multiplexer using the disclosed techniques;

FIG. 9B illustrates a second embodiment of a multiplexer using the disclosed techniques;

FIG. 10 illustrates the implementation of a “NAND” logic function;

FIG. 11 illustrates the implementation of a “NOR” logic function;

FIG. 12 illustrates the implementation of a “INVERT” logic function;

FIG. 13 illustrates the implementation of a “BUFFER” logic function;

FIG. 14 illustrates the implementation of a “XOR” logic function;

FIG. 15 illustrates the implementation of a “XNOR” logic function;

FIG. 16A illustrates an IBG device having active components;

FIG. 16B illustrates alternative embodiments of IBG devices having active components;

FIG. 17 illustrates a circuit comprised of resistors;

FIG. 18 illustrates a side view of a silicon wafer having active devices;

FIG. 19 shows 2 transistor (2T) IBG ROM circuit in accordance with one aspect of the present invention;

FIG. 20 shows a 2×2 array of a 2T IBG ROM in accordance with the present invention;

FIG. 21 shows a functional block diagram of a 2T architecture ROM system in accordance with the present invention;

FIG. 22 shows an alternate embodiment of a 2T IBG ROM circuit in accordance with the present invention;

FIG. 23 shows 3 transistor (3T) IBG ROM bit-pair circuit in accordance with one aspect of the present invention;

FIG. 24 shows a functional block diagram of a 3T architecture ROM system in accordance with the present invention;

FIG. 25 shows a block diagram of an imaging cartridge chip including at least one IBG device in accordance with the present invention;

FIG. 26 shows a perspective view of an imaging cartridge chip including at least one IBG device attached to an imaging cartridge in accordance with the present invention;

FIG. 27 shows a side sectional view of an exemplary CMOS pair including an IBG device in accordance with the present invention;

FIG. 28 shows a top plan view of the exemplary CMOS pair of FIG. 27;

FIGS. 29A and 29B show cross sectional views of an IBG fabrication that illustrates the transistor source/drain regions and associated implanted interconnects in accordance with the present invention;

FIGS. 30 and 31 illustrate an example of how IBG bit content can be programmed to change the logic function of an exemplary basic logic block in accordance with the present invention;

FIG. 32 is a plan view of the semiconductor device which appears to be a field effect transistor (FET);

FIGS. 32A, 32B, and 32C are cross sectional views of the semiconductor device of FIG. 32; and

FIGS. 33A and 33B show prior art devices;

FIG. 34 depicts artifact edges of a silicide layer of an IBG device in accordance with the present invention;

FIG. 35 shows an IBG circuit in accordance with the present invention;

FIGS. 36-38 show block diagrams of an IBG encryption and decryption system in accordance with the present invention;

FIG. 39 shows an IBG protected secure video transmission system in accordance with the present invention;

FIG. 40 shows an IBG protected smart card system in accordance with the present invention;

FIG. 41 shows an IBG protected RFID system in accordance with the present invention; and

FIG. 42 shows a method of forming an IBG protected security system in accordance with the present invention;

FIG. 43 illustrates transmitting encrypted data and decrypting the data.

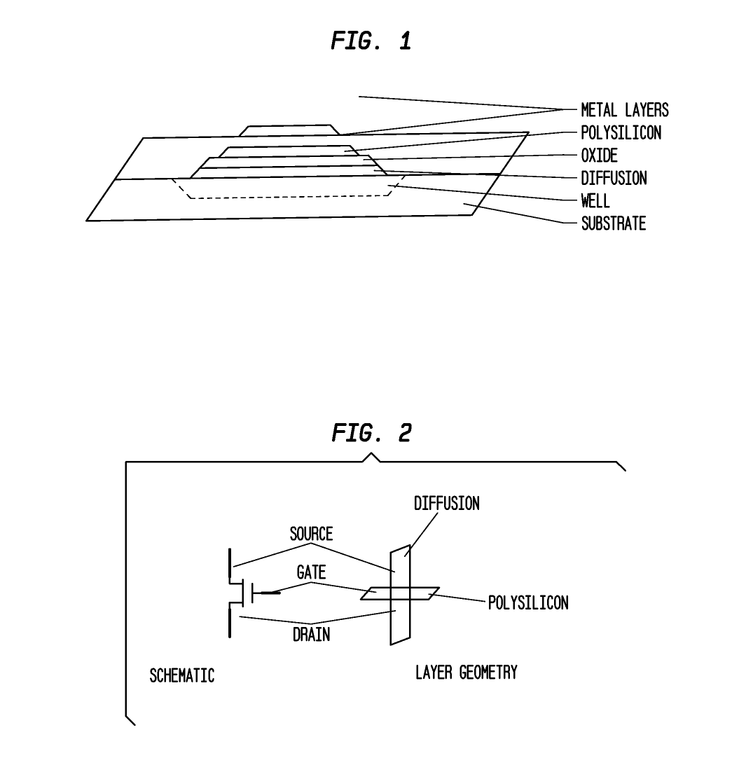

### DETAILED DESCRIPTION OF THE DRAWINGS

Many semiconductor processes that contain logic functions provide different types of metal-oxide-semiconductor (MOS) devices to be used in different environments. For example, one device can operate only at lower voltages and can be sized to minimum geometry. Another device can operate at higher voltages and cannot be sized to minimum geometry. Using this type of device allows the semiconductor device to interface to external signals that are higher in voltage when compared to the internal minimum sized devices.

The type of MOS device in the previous example is typically controlled by the electrical characteristics of the diffusion material. These characteristics are changed by slightly altering the atomic structure of this material by using an ion implant dose and energy. This process is normally described as “doping”. This slight change of electrical properties cannot be detected by the conventional reverse engineering teardown techniques.

In order to provide a device that is resistant to these reverse engineering techniques, an invisible bias generator (IBG) has been developed. An IBG may be defined as an electronic device having at least two internal devices where the physical geometries of the internal devices cannot be used to determine the operating characteristics of the IBG.

One example of an IBG is a device where both internal devices have the same geometry but operate differently. For example, the first device may be a transistor that operates at a first voltage level and the second device is a transistor that operates at a different voltage level. In another example, the first device is a silicide resistor while the second device is a non-silicide resistor. In another example, conductive ink is used to create an electronic circuit and the amount of conductive material in the ink is changed between two of the elements.

Another example of an IBG is a device where both internal devices have different geometries but have the same operating characteristics. For example, the first device may be a transistor that operates with first characteristics and the second device is larger a transistor that operates with the same characteristics. In another example, the first device is a silicide resistor while the second device is a non-silicide resistor. In another example, conductive ink is used to create an electronic circuit and the amount of conductive material in the ink is changed between two of the elements.

Another example of an IBG circuit includes devices having multiple possible geometries and multiple possible operating characteristics, with no apparent correlation existing between a given geometry and an operating characteristic.

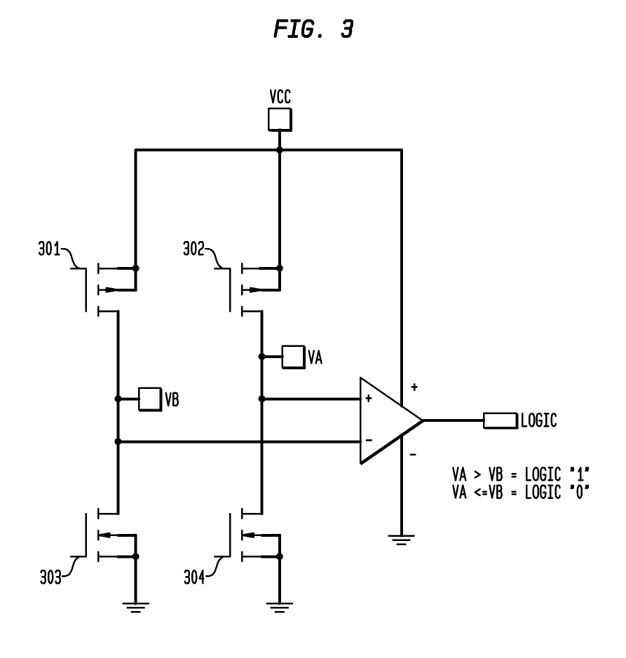

FIG. 3 illustrates an exemplary IBG circuit 300 that provides an effective deterrent to semiconductor device teardown techniques. The circuit 300 includes a first IBG device comprising a P-channel device 301 and an N-channel device 303 which are connected in series between a power source (VCC) and a ground. A second IBG device comprises a P-channel device 302 and an N-channel device 304 also connected in series between VCC and ground. In one aspect of the present invention, the devices 301-304 may comprise MOS transistors. In a preferred embodiment, the devices 301-304 may also exhibit identical device geometry. The gates on the P-channel devices 301, 302 are floating as they not provided with an input signal (floating gates) and are charged via leakage current to a voltage level approximately VCC minus the threshold voltages of the devices 301 and 302, each of the threshold voltages is independent. The gates on the N-channel devices 303, 304 are also floating gates and are charged via leakage current to a voltage level of approximately ground plus the threshold voltages of the devices 303 and 304.

Each device 301-304 may include a conduction channel between a source and a drain of the device. The depth of the conduction channel is determined by the doping levels of the diffusion (also known as implantation) areas of the gates of devices 301-304 which in turn determine the voltage level on the P and N channel device junctions, labeled VA and VB in FIG. 3. In one aspect of the present invention, the devices 301-304 are formed with different doping levels (also called impurity levels) between at least some of the devices 301-304 while maintaining identical device geometry, thus resulting in the device junctions VA and VB having different voltage levels. A comparator 310 detects the voltage levels of VA and VB and based on the difference in these voltage bias levels outputs a logical“1” or “0”. VA and VB can be any voltage level as the logic criteria of the comparator 310 is based on the difference of these voltages. In a preferred embodiment, the circuit of FIG. 3 contains identical geometry for the P and N channel devices 301-304, thus causing the doping level difference between the devices 301-304 to control the difference in the voltage levels of the device junctions VA and VB. For example, if devices 301 and 303 are doped to form low voltage MOS transistors (such as 2.5V, for example) and if devices 302 and 304 are doped differently to form high voltage MOS transistors (such as 3.3V, for example), then device junction VA is at a higher voltage than device junction VB, and the output of the comparator will be a logical “1”. As another example, if devices 301 and 304 are doped to form low voltage MOS transistors, and if devices 302 and 303 are doped to form high voltage MOS transistors, then device junction VA is at a lower voltage than device junction VB, and the output of the comparator will be a logical “0”. The logic function of this circuit is invisible to reverse engineering teardown techniques since the operating voltages of the device junctions VA and VB are controlled by the doping levels and these doping levels are not determinable by conventional techniques.

For semiconductor technologies which provide different types of MOS devices, such as the high and low voltage devices described above, an advantage of the IBG circuit is that it can be easily constructed with current methods. Also, an IBG circuit in accordance with one aspect of the present invention can be used to create a number of different of logic cells by varying the number of high voltage devices and low voltage devices.

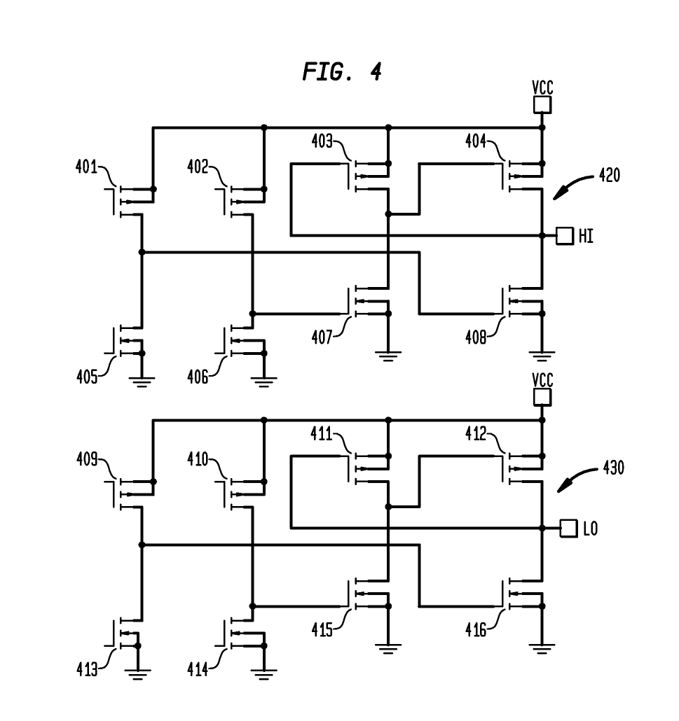

FIG. 4 shows an exemplary circuit 420 including an IBG and a level shifter circuit which produces a logical “1”, or high, output in accordance with one aspect of the present invention. The IBG portion of the circuit 420 comprises transistors 401, 402, 405, and 406 each having a floating gate input. P-channel transistor 401 is connected in series with N-channel transistor 405 at output node 401A, and P-channel transistor 402 is connected in series with N-channel transistor 406 at output node 402A. Each of the transistors of the IBG portion of the circuit can be a P-type or an N-type device. Also each transistor can be a high voltage device or a low voltage device. In a preferred embodiment, a high voltage device operates at 3.3 V while a low voltage device operates at 2.5 V. In an exemplary embodiment, transistor 402 is a low voltage P-type device, transistor 401 is a high voltage P-type device, transistor 405 is a low voltage N-type device, and transistor 406 is a high voltage N-type device, resulting in the voltage level at output node 402A being higher than the voltage level at the output node 401A. For example, transistors 401 and 405 may produce a voltage level of about 100 mV at the output node 401A and transistors 402 and 406 may produce a voltage level of about 1.5 V at the output node 402A. These output levels fall short of being VCC and ground due to transistors 401, 402, 405, and 406 not being fully turned ON or OFF by the charge on their floating gates which are charged by leakage currents. Transistors 401, 402, 405 and 406 are selected to ensure the voltage levels of the output nodes 401A and 402A are such the one voltage level is higher and the other voltage level is lower than the threshold voltage of transistors 407 and 408, described below.

The voltage levels of the output nodes 401A and 402A of the IBG circuit are insufficient to interface directly with digital logic due to the voltage level of the gates of the transistors 401, 402, 405 and 406. To properly interface with digital logic, the signals from the output nodes 401A and 402A are input to a level shifting circuit comprising transistors 403, 404, 407 and 408. Transistors 403 and 404 may comprise low voltage P-type devices and transistors 407 and 408 may comprise low voltage N-type devices. The output node 401A of the IBG circuit is connected to the gate of N-channel transistor 408 of the level shifting circuit and the output node 402A of the IBG circuit is connected to the gate of the N-channel transistor 407 of the level shifting circuit. In an exemplary embodiment, the N-channel transistors may have a threshold voltage of about 700 mV. Thus, the 100 mV voltage level of node 401A which is input to the gate of transistor 408 will turn transistor 408 “OFF” and the 1.5 V voltage level which is input to the gate of transistor 407 will turn transistor 407 “ON”. Thus, transistor 403 will be turned “OFF” and transistor 404 will be turned “ON”, resulting in the output of the level shifting circuit being a logical “1” or HI.

FIG. 4 also shows also an exemplary circuit 430 including an IBG and level shifting circuit which produces a logical “0”, or low, output in accordance with one aspect of the present invention. The IBG portion of the circuit 420 comprises transistors 409, 410, 413, and 414 each having a floating gate input. P-channel transistor 409 is connected in series with N-channel transistor 413 at output node 409A, and P-channel transistor 410 is connected in series with N-channel transistor 414 at output node 410A. Each of the transistors of the IBG portion of the circuit can be a P-type or an N-type device. Also each transistor can be a high voltage device or a low voltage device. In a preferred embodiment, a high voltage device operates at 3.3 V while a low voltage device operates at 2.5 V. In an exemplary embodiment, transistor 409 is a low voltage P-type device, transistor 410 is a high voltage P-type device, transistor 413 is a high voltage N-type device, and transistor 414 is a low voltage N-type device, resulting in the voltage level at output node 409A being higher than the voltage level at the output node 410A. For example, transistors 410 and 414 may produce a voltage level of about 100 mV at the output node 410A and transistors 409 and 413 may produce a voltage level of about 1.5 V at the output node 409A. Transistors 409, 410, 413 and 414 are selected to ensure the voltage levels of the output nodes 409A and 410A are such the one voltage level is higher and the other voltage level is lower than the threshold voltage of transistors 415 and 416, described below.

The voltage levels of the output nodes 409A and 410A of the IBG circuit are insufficient to interface directly with digital logic due to the voltage level of the gates of the transistors 409, 410, 413 and 414. To properly interface with digital logic, the signals from the output nodes 409A and 410A are input to a level shifting circuit comprising transistors 411, 412, 415 and 416. Transistors 411 and 412 may comprise low voltage P-type devices and transistors 415 and 416 may comprise low voltage N-type devices. The output node 409A of the IBG circuit is connected to the gate of N-channel transistor 416 of the level shifting circuit and the output node 410A of the IBG circuit is connected to the gate of the N-channel transistor 415 of the level shifting circuit. In an exemplary embodiment, the N-channel transistors may have a threshold voltage of about 700 mV. Thus, the 1.5 V voltage level of node 409A which is input to the gate of transistor 416 will turn transistor 416 “ON” and the 100 mV voltage level which is input to the gate of transistor 415 will turn transistor 415 “ON”. Thus, transistor 412 will be turned “OFF” and transistor 411 will be turned “ON”, resulting in the output of the level shifting circuit being a logical “0” or LO.

As described above, the circuit 420 gives the “HI” voltage output while circuit 430 gives the “LO” voltage output. The geometry and size of the IBG transistors 401, 402, 405 and 406 of the circuit 420 may be identical to the geometry and size of the IBG transistors 409, 410, 413 and 414 of the circuit 430. The only discernible difference between the two devices is the level of doping between the high voltage transistors and the low voltage transistors. Because the size and the geometry of IBG transistors of device 420 may be identical to the IBG transistors of device 430, it is not possible to determine the difference between these two devices using the conventional reverse engineering teardown techniques.

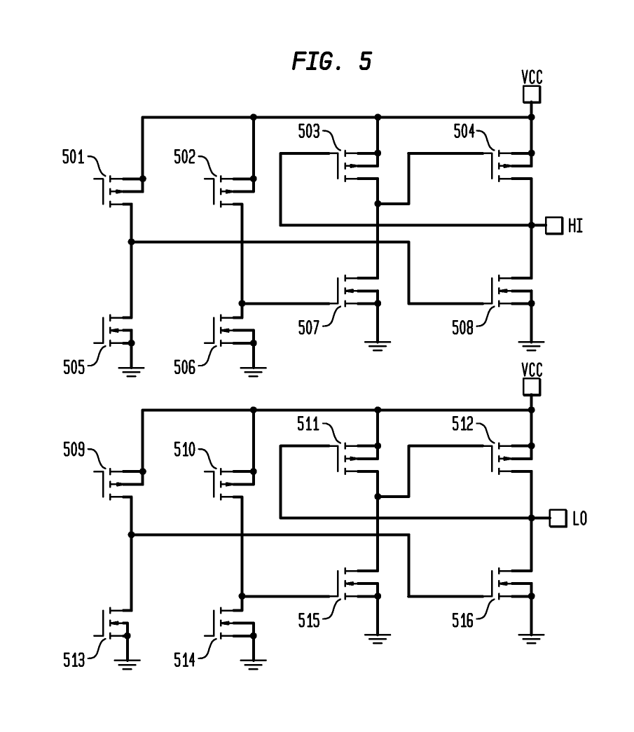

FIG. 5 illustrates a second example of IBG circuits and level shifting circuits to output a “HI” or “LO” output. Similar to the embodiment shown in FIG. 4, there are 16 transistor devices (501 through 516). Each of the transistors can be a P-type or an N-type device. Also each device can be a high voltage device or a low voltage device. In a preferred embodiment, a high voltage device operates at 3.3 V while a low voltage device operates at 2.5 V. In an exemplary embodiment, transistors 502, 503, 504, 509, 511, and 512 are low voltage P-type devices. Transistor 501 and 510 are high voltage P-type devices. Transistors 505, 507, 508, 514, 515, and 516 are low voltage N-type devices. Transistors 506 and 513 are high voltage N-type devices. Device 520 gives the “HI” voltage output while device 530 gives the “LO” voltage output. The geometry and size of the IBG transistors 501, 502, 505, and 506 of the device 520 may be identical to the geometry and size of transistors 509, 510, 513 and 514 of device 530. The only discernible difference between the two devices is the level of doping between the high voltage transistors and the low voltage transistors. Because the size and the geometry of the IBG transistors of device 520 is identical to that of the IBG transistors of device 530 it is not possible to determine the difference between these two devices using the conventional reverse engineering teardown techniques.

If a semiconductor chip contains an IBG as described in FIG. 4 or FIG. 5, it is extremely difficult for someone trying to reverse engineer the chip using teardown techniques to determine the function of the IBG devices placed on the chip because the geometry of the internal devices are the same.

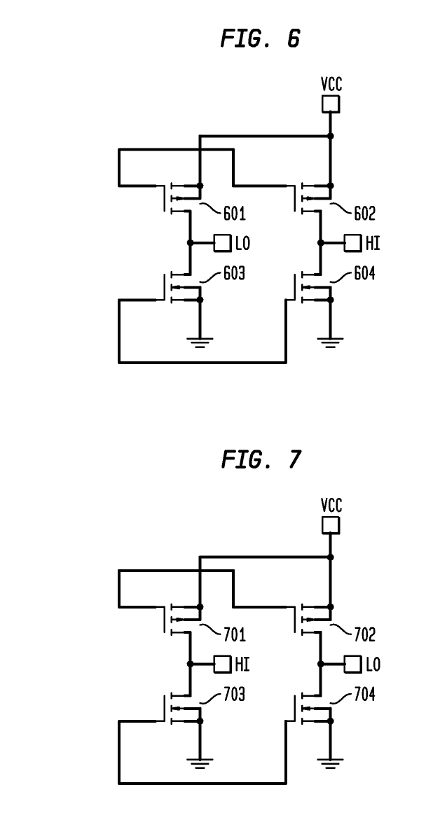

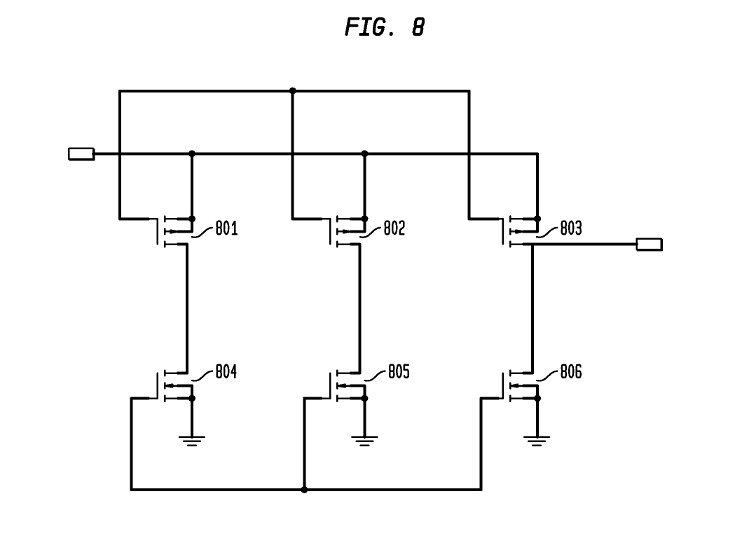

FIG. 6 and FIG. 7 illustrate examples of IBGs where the voltage levels of the outputs of the circuits are sufficient to directly interface with the devices on a chip. In FIG. 6, device 601 is a high voltage P-type device, such as 3.3 v, device 602 is a low voltage P-type device, such as 2.5 v, device 603 is a low voltage N-type device and 604 is a high voltage N-type device. By connecting the gate of device 601 to the gate of device 602, these devices share the leakage current, resulting in the high voltage device 601 being fully turned OFF and the low voltage device 602 being fully turned ON. Similarly, by connecting the gate of device 603 to the gate of device 604, these devices share the leakage current, resulting in the low voltage device 603 being fully turned ON and device 604 being fully turned OFF. Output node 601A will be sufficiently close to ground to function as a logical “0” and interface directly with other CMOS devices and output node 602A will be sufficiently close to VCC to function as a logical “1” and interface directly with other CMOS devices.

In FIG. 7, device 701 is a low voltage P-type device, such as 2.5 V, device 702 is a high voltage P-type device, such as 2.5 V, device 704 is a low voltage N-type device and 703 is a high voltage N-type device. By connecting the gate of device 701 to the gate of device 702, these devices share the leakage current, resulting in the low voltage device 701 being fully turned ON and the high voltage device 702 being fully turned OFF. Similarly, by connecting the gate of device 703 to the gate of device 704, these devices share the leakage current, resulting in the high voltage device 703 being fully turned OFF and low voltage device 704 being fully turned ON. Output node 701A will be sufficiently close to VCC to function as a logical “1” and interface directly with other CMOS devices and output node 702A will be sufficiently close to ground to function as a logical “0” and interface directly with other CMOS devices.

The geometry and size of the IBG transistors 601, 602, 603 and 604 may be identical to the geometry and size of the IBG transistors 701, 702, 703 and 704 The geometry and size of IBG transistors 601, 602, 603, and 604 may not be identical to each other. The geometry and size of IBG transistors 701, 702, 703 and 704 may not be identical to each other. Additionally, the voltage levels at the gates of the gate connected transistors are equal. The only discernible difference between the two devices is the level of doping between the high voltage transistors and the low voltage transistors. Because the size and the geometry of IBG transistors of FIG. 6 may be identical to the IBG transistors of device FIG. 7, it is not possible to determine the difference between these two devices using the conventional reverse engineering teardown techniques. The IBG shown in FIG. 6 has the same geometry as the IBG shown in FIG. 7 with the only difference being the doping level of some of the transistors. Therefore, if a chip is designed using the IBG illustrated in FIG. 6 and the IBG illustrated in FIG. 7, it is very difficult to determine a difference in the function of the devices made by each design.

The IBG shown in FIG. 6 can include different configurations. In one example, device 601 is a low voltage P-type device, device 602 is a high voltage P-type device, device 603 is a low voltage N-type device and 604 is a high voltage N-type device. In another example device 601 is a high voltage P-type device, device 602 is a low voltage P-type device, device 603 is a high voltage N-type device and 604 is a high voltage N-type device. In another example device 601 is a high voltage P-type device, device 602 is a low voltage P-type device, device 603 is a low voltage N-type device and 604 is a low voltage N-type device. In another example device 601 is a high voltage P-type device, device 602 is a low voltage P-type device, device 603 is a low voltage N-type device and 604 is a high voltage N-type device. There are a total of sixteen configurations possible for a four device IBG.

FIG. 8 illustrates another embodiment of an IBG circuit. Devices 801, 802, 803 are shown as P-type devices and can be any combination of high voltage or low voltage devices. Devices 804, 805, 806 are shown as N-type devices and can be any combination of high voltage or low voltage devices. However, the six devices shown can be any combination of P-type and N-type devices. The six device IBG has a total of 64 possible configurations. Furthermore, an IBG can be comprised of any number of active devices with 2 to the “n” number of combinations, where n is the number of active devices.

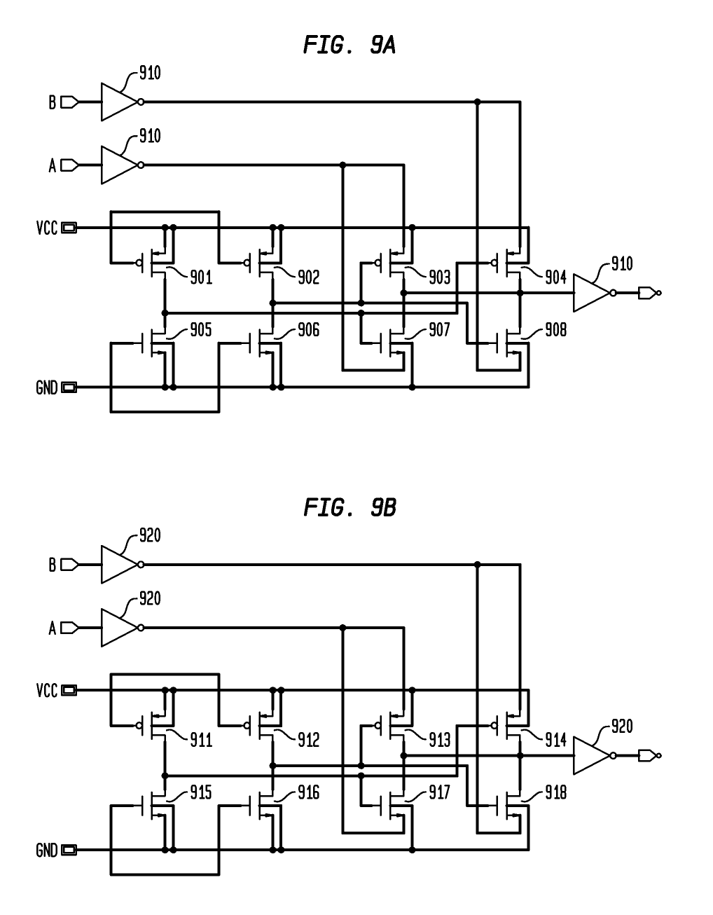

FIG. 9A and FIG. 9B illustrate IBG circuits which include multiplexers. Because IBG circuits may be used to select logic functions, it is convenient to implement these circuits in conjunction with digital multiplexers that effectively steer one of two inputs to its output. These IBG based multiplexers select an input base solely on the IBG function. In FIG. 9A, transistors 901, 902, 905 and 906 comprise an IBG circuit and transistors 903, 904, 907 and 908 comprise a multiplexer. In FIG. 9B, transistors 911, 912, 915 and 916 comprise an IBG circuit and transistors 917, 918, 913 and 914 comprise a multiplexer. In FIG. 9A, devices 901 and 906 are 3.3V devices while devices 902, 903, 904, 905, 907, and 908 are 2.5V devices. Inverter 910 provides the inverse of input A and the inverse of input B. In FIG. 9B, devices 912 and 915 are 3.3V devices while devices 911, 913, 914, 916, 917, and 918 are 2.5V devices. Inverter 920 provides the inverse of input A and the inverse of input B. Based on the outputs of the IBG transistors 901, 902, 905 and 906, the multiplexer shown in FIG. 9A selects the B input while the multiplexer shown in FIG. 9B selects the A input based on the outputs of the IBG transistors 911, 912, 915 and 916. The only discernible difference between the two devices is the level of doping between the high voltage transistors and the low voltage transistors. Because the size and the geometry of transistors of FIG. 9A may be identical to the transistors of FIG. 9B, it is not possible to determine the difference between these two devices using the conventional reverse engineering teardown techniques. The IBG shown in FIG. 9A may have the same geometry as the IBG shown in FIG. 9B with the only difference being the doping level of some of the transistors. Therefore, if a chip is designed using the circuit illustrated in FIG. 9A and the circuit illustrated in FIG. 9B, it is very difficult to determine a difference in the function of the devices made by each design. The only difference between these circuits is the configuration of 3.3V and 2.5V devices.

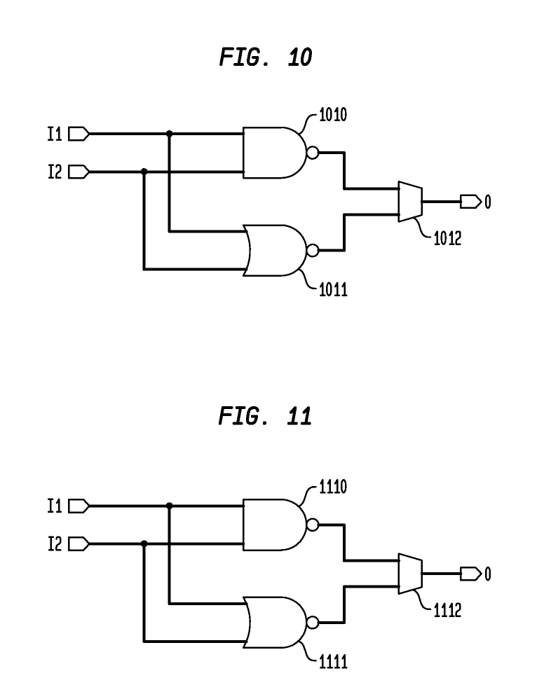

FIG. 10 represents the implementation of a “NAND” logic function and FIG. 11 illustrates the implementation of a “NOR” logic function. In FIG. 10, NAND gate 1010 and NOR gate 1011 output to an IBG based multiplexer 1012, such as the IBG circuit multiplexer shown in FIG. 9A, which selects the output of the NAND gate 1010. In FIG. 11, NAND gate 1110 and NOR gate 1111 output to an IBG based multiplexer 1112, such as the IBG circuit multiplexer shown in FIG. 9B, which selects the output of the NOR gate 1111. These two implementations appear to identical during reverse engineering because the difference between these configurations is the IBG circuit. Without knowledge of the IBG circuit the logic function of these configurations is indeterminate.

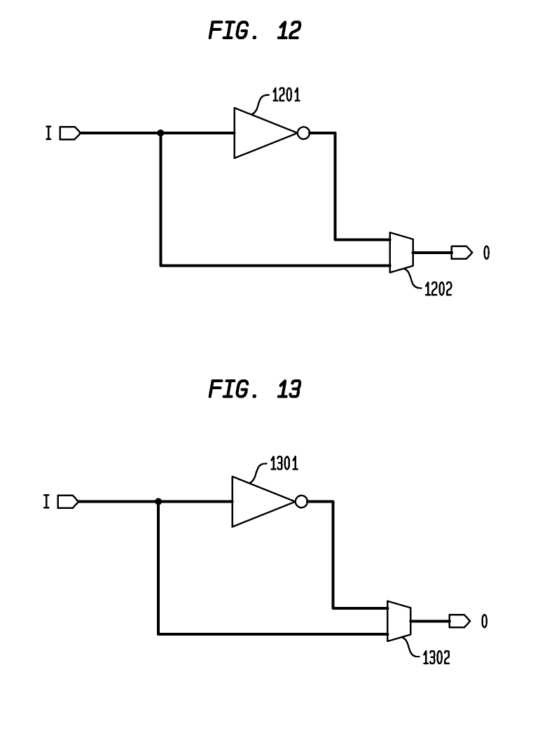

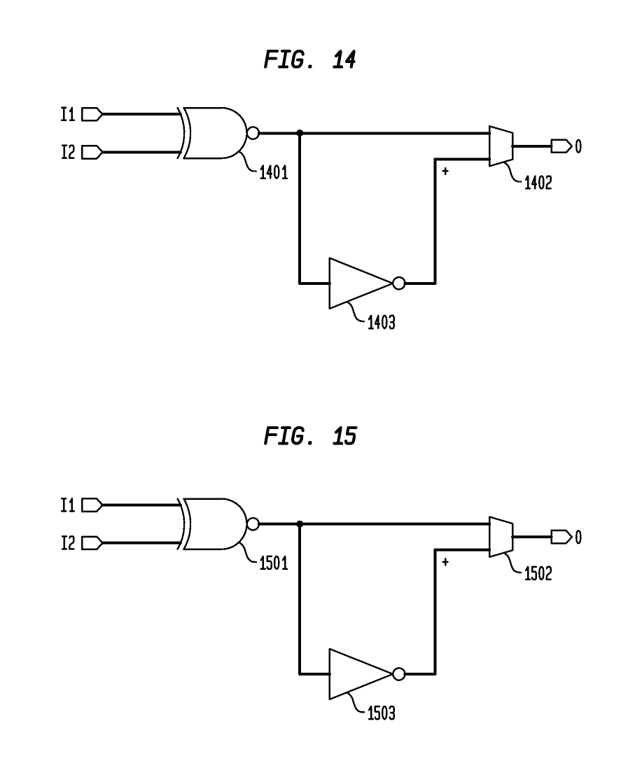

FIG. 12 illustrates an implementation of the logic function “INVERT” comprising an inverter 1201 and an IBG based multiplexer 1202, such as the IBG circuit multiplexer shown in FIG. 9A, implemented to select the inverted input. FIG. 13 illustrates an implementation of the logic function “BUFFER” comprising an inverter 1301 and an IBG based multiplexer 1302, such as the IBG circuit multiplexer shown in FIG. 9B, implemented to select the non-inverted input. FIG. 14 illustrates an implementation of the logic function “XOR” comprising an exclusive-or gate 1401, an inverter 1403 and an IBG based multiplexer 1402, such as the IBG circuit multiplexer shown in FIG. 9A, implemented to select the output of the gate 1401. FIG. 15 illustrates an implementation of the logic function “XNOR” comprising an exclusive-nor gate 1501, an inverter 1503 and an IBG based multiplexer 1502, such as the IBG circuit multiplexer shown in FIG. 9B, implemented to select the output of the inverter 1503. As with the previous examples, reverse engineering a chip that has both the “INVERT” of FIG. 12 and the “BUFFER” of FIG. 13 will be difficult to perform because the “INVERT” and the “BUFFER” will have the same appearance. Reverse engineering a chip that has both the “XOR” of FIG. 14 and the “XNOR” of FIG. 15 is difficult because the “XOR” and “XNOR” have the same appearance. As described above, each pair of implementations is indeterminate without knowledge of the logical operation of the IBG circuit based multiplexers.

One advantage of the high voltage/low voltage method of anti-reverse engineering deterrent is that most processes support this distinction. Many implementations are designed to use low voltages internal voltages because as feature size decreases the internal voltage decreases. But, many devices outside of the chip operate at higher voltages and the chips must be able to interface with these devices. Therefore, devices that use higher voltages are still used and being developed. It is possible to for the difference between the low voltage device and the high voltage device to be achieved using small doping changes between P and N devices.

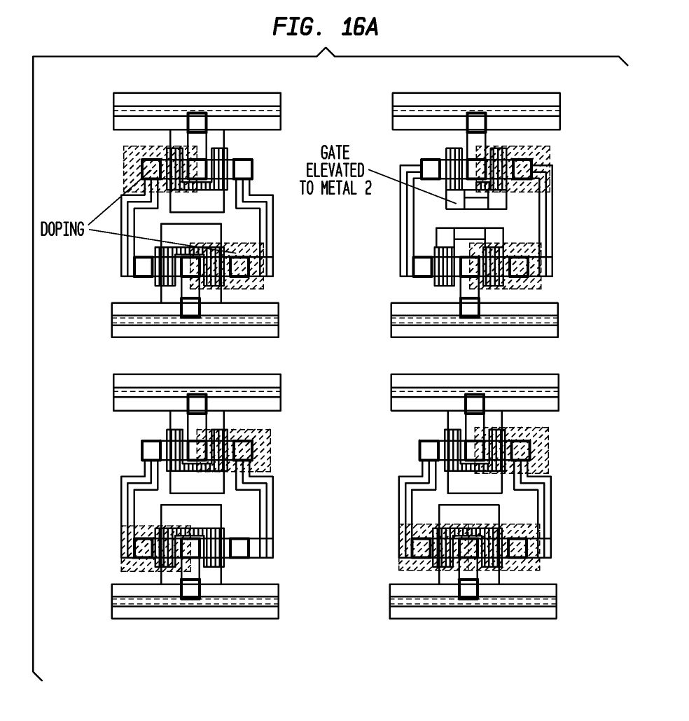

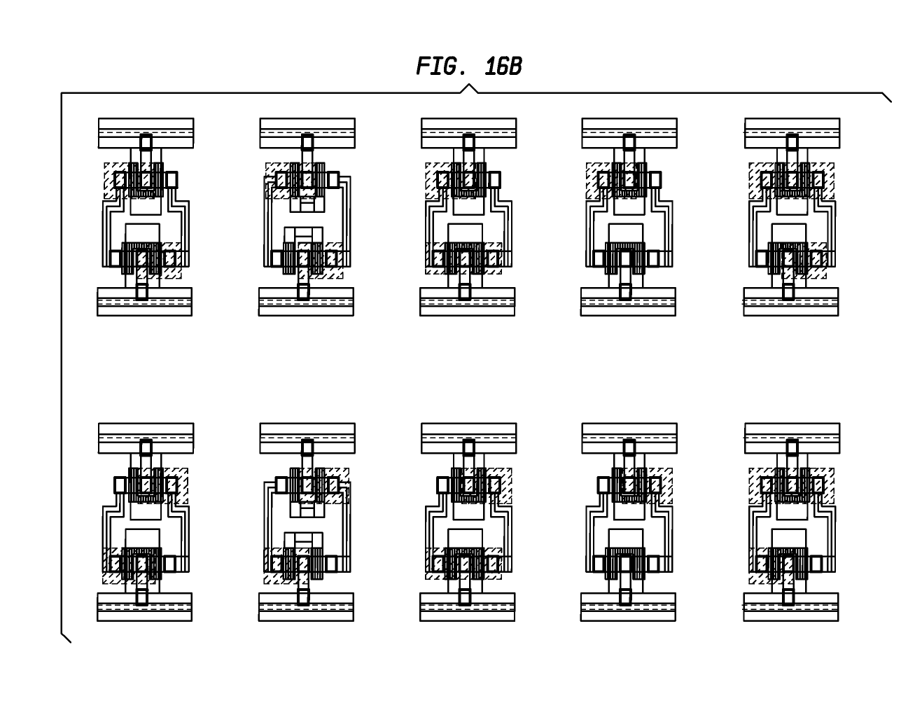

The IBG devices described above include active devices that use the dopant level to control characteristics of the devices. As an example, it is known in a particular process that a doping concentration difference between the 2.5V and 3.3V devices is about 8×E16 atoms/cm3. Structures that have doping density differences below 1×E17 are candidates for IBG design. Examples of IBGs are in FIG. 16.

There are many other combinations of devices that will work besides the 2.5V and 3.3V devices. For example, a 2.5V can be used with a 5V device. A 1.8V device, a 1.5V device, or a 1.2V can be used with a 3.3V device. A 1.2V device can be used with 1.8V or a 2.5V device. A 1.0V device can be used with a 1.8V device, 2.5V device, or a 3.3V device. A 0.85V device can be used with a 1.8V device, a 2.5V device, or a 3.3V device. This list is exemplary only and any combination of devices that can be made with the same physical geometry can be used.

The previous examples illustrate some of the possible implementations of IBG devices using active devices. Another way to achieve an IBG device is to use inactive devices. The IBG can be made using a silicide poly resistor and a non-silicide poly resistor. The first device is used to set the first bias voltage as an active bias voltage and the second device is used to set the set the second bias voltage as an active bias voltage. The difference between the silicide poly resistor and the non-silicide poly resistor will not be apparent to the conventional reverse engineering techniques because the resistors have the same geometry. FIG. 16A illustrates an example of an IBG device. FIG. 16B illustrates other examples of an IBG device.

Polysilicon has fairly high resistivity, about a few hundred μΩ-cm. Resistive devices from polysilicon suffer from this high resistivity because as the device dimension shrinks the resistance of the polysilicon local interconnection increases. This increased resistance causes an increase in the power consumption and a longer RC time delay. Silicides are added to polysilicon devices because the addition of the silicides reduces the resistance and increases device speed. Any silicide that has a much lower resistivity than polysilicon may be used. Titanium silicide (TiSi₂) and tungsten silicide (WSi₂) are two silicides that are commonly used.

Next, one method of forming a silicide device is described. A self-aligned silicide process is conventionally used to from Titanium Silicide. Initially, chemical solutions are used to clean the wafer surface in order to remove contaminants and particles. Next, the wafer is sputtered in a vacuum chamber using argon to remove the native oxide from the wafer surface. Next, a layer of the wafer surface is sputtered to deposit a layer of titanium on the wafer surface. This results in a wafer having the silicon exposed at the source/drain and on top of the polysilicon gate. Next, a titanium silicide is formed on the polysilicon by using a thermal annealing process. For example, annealing can be performed in a rapid thermal process to form titanium silicide on top of the polysilicon and on the surface of the source/drain. Because titanium does not react with silicon dioxide, silicide is formed only where polysilicon directly contacts with titanium. Next, the unreacted titanium is removed by using a wet etch process that exposes the unreacted titanium to a mixture of hydrogen peroxide (H₂O₂) and sulfuric acid (H₂SO₄). Lastly, the wafer is annealed which increases the grain size of the titanium Silicide. The increased grain size improves the wafer's conductivity and reduces wafer's contact resistance.

Another characteristic that can be controlled in the IBG device is the threshold voltage. The threshold of MOS transistors can be controlled by threshold adjustment implant. An ion implantation process is used to ensure that the power supply voltage of the electronic systems can turn the MOS transistor in the IC chip on and off. The threshold adjustment implantation is a low-energy and low current implantation process. Typically, the threshold adjustment implantation is performed before gate oxide growth. For CMOS IC chips, two threshold adjustment implantation processes are needed, one for p-type and one for n-type.

In an IBG device, the process described above can be used to produce resistors that have the same physical dimensions and have different resistance. Conversely, the process can be used to produce resistors that have different geometries and the same resistance.

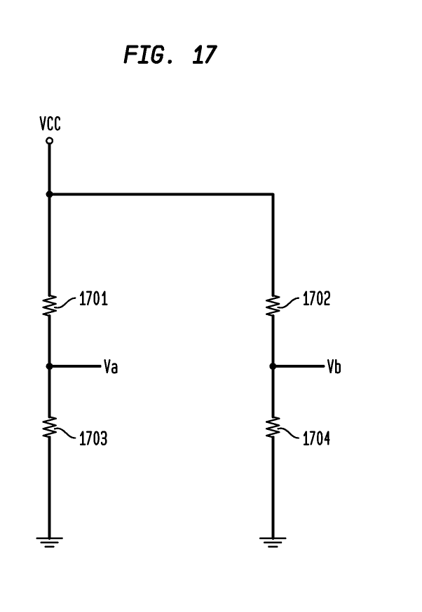

FIG. 17 illustrates an example of an IBG device implemented by silicide resistors. A voltage source VCC is connected to a circuit having resistors 1701, 1702, 1703, 1704. The resistance of the resistors can be set by the method described above to have two different resistance levels with all of the resistors having the same physical geometry. For example, resistors 1701 and 1704 may be non-silicide resistors while resistors 1702 and 1703 are silicide resistors. In this example if Va is less than Vb then the output of the device is a logic “1.” If Va is greater than or equal to Vb then the output of the device is a logic “0.”

In another embodiment, the devices can be formed using conductive inks. Conductive inks are used to print circuits on a variety of substrate materials. Conductive inks contain conductive materials such as powdered or flaked silver materials.

Conductive inks can be used to implement IBG circuits because the properties of the inks used to print the circuit can be varied to create devices that have different properties. For example, some devices can be printed using conductive ink having an amount of conductive material. Then, conductive ink that has more (or less) conductive material is used to print another portion of the circuit. The circuit then can have devices that look similar and operate differently or look different and operate the same.

One possible method of reverse engineering IBG circuits is to physically measure the devices in the circuit. This can be done using a probe to measure the actual voltage generated by the circuit. In order to thwart this method of reverse engineering, the IBG cells are placed randomly spaced throughout the design. This makes it more difficult to probe the large number of IBG circuits required to reverse engineer the design.

In an alternative embodiment, the types of IBG circuits used are randomly distributed. For example, every third “AND” gate is implemented using an IBG circuit while every fourth “NAND” gate is implemented using an IBG circuit. As the number of devices implemented by IBG circuits is increased, the difficulty in reverse engineering the chip is increased. Additionally, as the number of types of logic devices implemented by IBG is increased, the difficulty in reverse engineering the chip is increased.

In another embodiment, logic blocks are made having logic devices therein. Within each logic block, the IBGs are randomly distributed within the logic block. As a result, different types of logic devices within each logic block are comprised of IBG devices.

In another embodiment, logic blocks are made having logic devices. The designer determines for the logic blocks a critical point and uses an IBG to implement the critical point. The critical point is a point within the logic the block where it is necessary to know the function or output value in order to determine the function of the logic block. Implementing the critical point within the logic block by an IBG is advantageous because this ensures that IBG has maximum effect in preventing reverse engineering. The inability to determine the value of critical point will necessarily prevent the reverse engineer from determining the proper function for the logic block.

For example, if the logic block is an ADDER, replacing a digit in the output can make it impossible to determine the function of the adder. That is because someone trying to reverse engineer the chip monitoring the function of the logic block would expect a specific output for an ADDER. When the replaced digit does not give the expected result, it is not determined that the logic block is functioning as and ADDER.

Another advantage of the disclosed system and method is that chip can be designed using standard tools and techniques. Methods of designing a chip are described in the following paragraphs.

A designer creates an overall design for the chip and for logic blocks within the chip. The design is created in a known hardware design language such as Verilog or VHDL. The design is then synthesized into standard logic which converts the design to the optimized gate level. Synthesis may be performed using standard synthesis tools such as Talus Design, Encounter RTL Designer, and Design Compiler. The synthesis maps the logic blocks into standard logic using a standard cell library provided by the supplier. Next, a place and route tool is used to create a physical implementation of the design. This step involves creating a floorplan, a power grid, placing the standard cells, implementing a clock tree, and routing connectivity between cells and input/output pins. Some examples of place and route tools are Talus Vortex, Encounter Digital Implementation, and IC Compiler. Using this process there are various ways to design a chip using IBG devices. One way is to create and characterize one or more new standard cell libraries and use the one or more new standard cells at the beginning of the process. Another approach is to place the IBG devices during the place and route step, either automatically or manually.

Another method of designing a chip is for the designer to create the design using a schematic entry tool. The designer creates a circuit by hand comprising the base logic gates. The designer can optimize the logic functionality using Karnaugh-maps. A layout entry tool is used to create the physical implementation of the design. The designer draws polygons to represent actual layers that are implemented in silicon. Using this approach the designer places IBG devices at any desired location.

Because the above devices result in a design that is difficult to reverse engineer using the conventional tear down techniques, another method may be implemented to reverse engineer the chip. Another known method of reverse engineering is to probe the device while active in order to establish the operating values of the internal devices. In order to perform these methods, the reverse engineer must remove some layers of the wafer to expose the output contacts of the devices. One way to make this technique more difficult is to randomly place the logic devices as described above. Another technique is to design a chip that is physically resistant to these techniques.

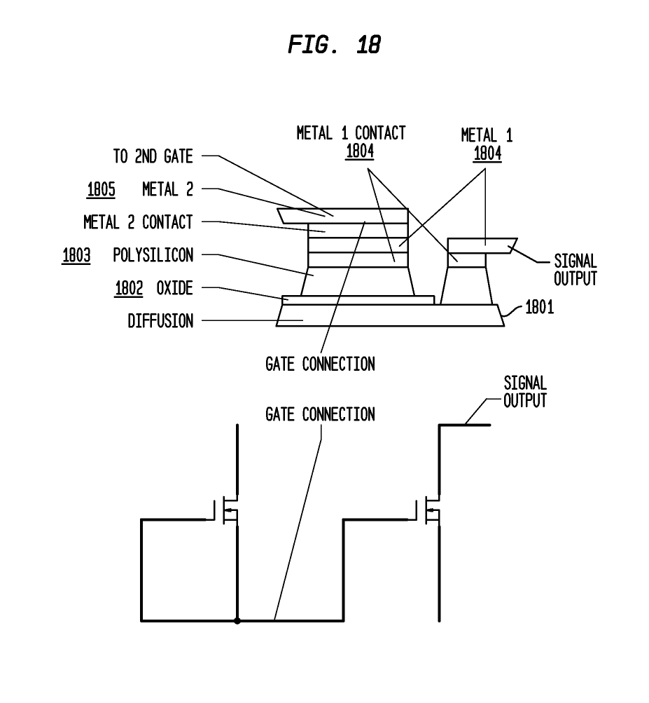

FIG. 18 illustrates the layers of a silicon wafer that is resistant to electronic testing of the chip. The wafer has a base layer 1801 that includes the diffusion layer. The oxide layer 1802 is on top of the diffusion layer 1801. The polysilicon layer 1803 is located on top of the oxide layer with the metal layer 1 1804 located thereon. The signal outputs are formed in metal layer 1 1804. Metal layer 2 1805 is located on top of the metal layer 1 1804. The gate connections are formed in metal layer 2 1805. With this layout it is necessary to remove a portion of metal layer 2 1805 in order to probe the signal outputs that are located in metal layer 1 1804. Removing a portion of metal layer 2 1805 disrupts the gate connections of the devices which in turn deactivates the devices. Thus, a reverse engineer trying to probe the device will destroy the functionally of the device during the reverse engineering process.

In many of the techniques described above, the output voltage level of a device is used to determine the operation of the device. But, any other operating characteristic of the device could be used. For example, the rise time of the device, the current drawn, or the operating temperature can be used in the IBG. Also, more than one physical property of the device can be varied. For example, the geometry and the doping level can be controlled to implement an IBG.

Another advantage of the disclosed system and method is that it can be implemented in any type of electronic device. For example, a read-only memory (ROM) can be implemented with the techniques described above and the contents of the memory are protected by the physical implementation of the IBG circuit. This enables a protected memory device without the need for complicated encryption techniques.

An IBG ROM circuit may be a masked memory technology that is highly resistant to hardware reverse engineering techniques. The IBG ROM circuit may be based on bit pairing of N and P channel devices with doping density differences too small to small to be determined by optical differentiation techniques. The IBG ROM increases the complexity and cost of reading out memory using optical reverse engineering processes, thus producing a secure environment for the data stored in the IBG ROM.

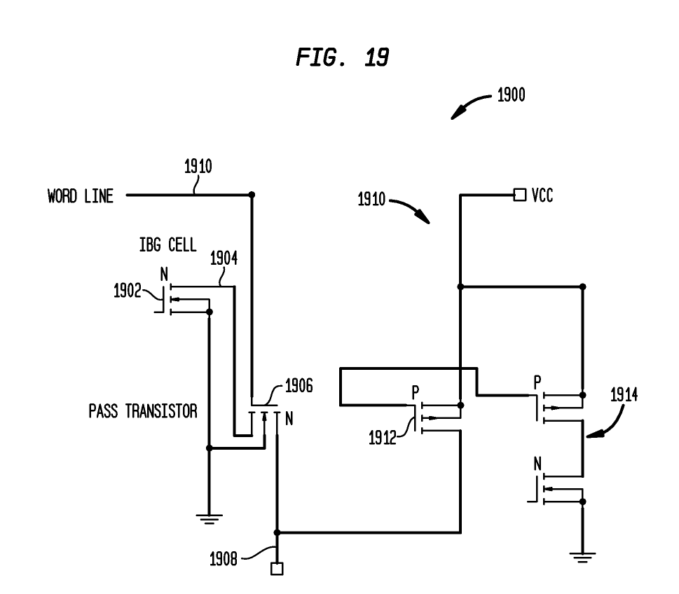

FIG. 19 shows 2 transistor (2T) IBG ROM circuit 1900 in accordance with one aspect of the present invention. The 2T IBG ROM circuit 1900 includes a first N channel transistor 1902 having an output node 1904 connected to the source terminal of the N channel transistor 1902. The N channel transistor 1902 is selected to have a device geometry and device characteristics, including doping characteristics, adapted to bias the output node 1904 at a predetermined voltage level indicating a binary 1 or a predetermined voltage level indicating a binary 0 when the N channel transistor 1902 is connected to a P channel device, described in greater detail below. The doping characteristic differences between a binary 1 and a binary 0 are too small to be detected by optical techniques. The gate terminal of the first N channel transistor 1902 is a floating gate and thus not connected to an input signal. The drain terminal of the first N channel transistor 1902 is connected to ground. The 2T IBG ROM circuit 1900 also includes a second N channel transistor 1906 connected between the output node 1904 and a data bus 1908. A word line 1910 is connected to the gate of the N channel transistor 1906. The N channel transistor 1906 operates as pass transistor and is turned ON by the word line 1910. When the pass transistor 1906 is turned ON by the word line 1910, the pass transistor passes the predetermined voltage level of the output node 1904 to the data bus 1908.

A common P channel circuit 1910 is also connected to the data bus and provides the leakage current to charge the floating gate in the first N channel transistor 1902 when the pass transistor 1906 is turned ON. The common P channel circuit 1910 includes a P channel transistor 1912 and a dummy P and N transistor pair 1914 connected in series. The gates of the P channel transistor 1912 and the dummy P transistor are connected, creating the leakage profile required for proper operation of the first N channel transistor 1902 when the pass transistor 1906 is turned ON. The predetermined voltage level will only be present at the output node 1904 when the pass transistor 1906 is turned ON and thus connecting the common P channel circuit 1910 to the transistor 1902 to provide the leakage current for the operation of the N channel transistor 1902.

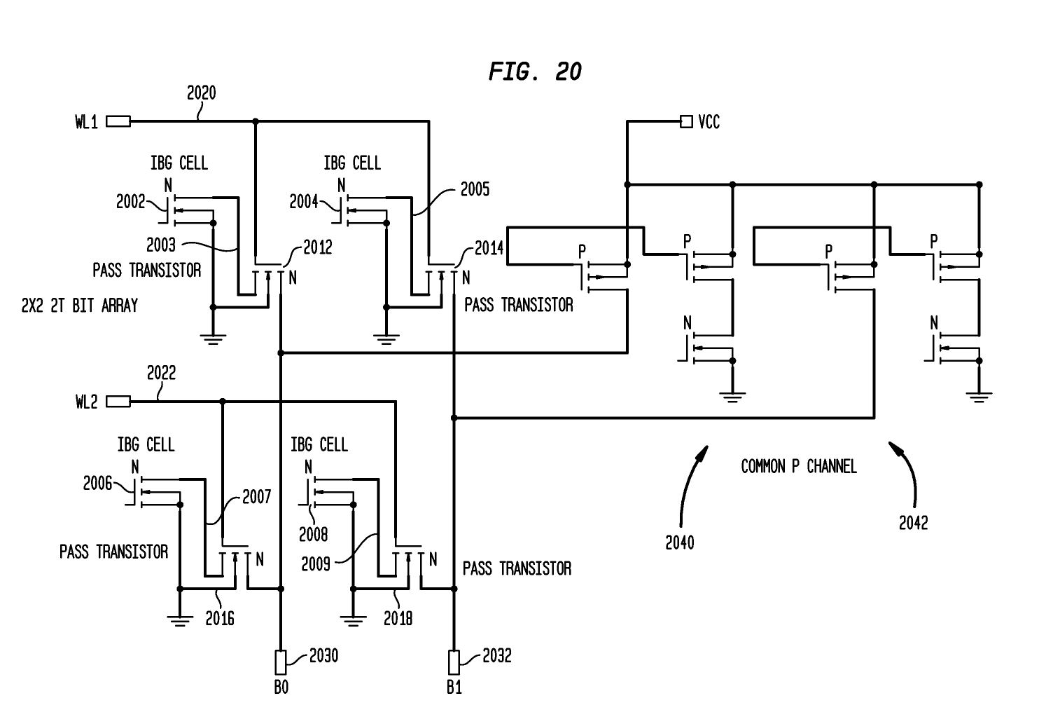

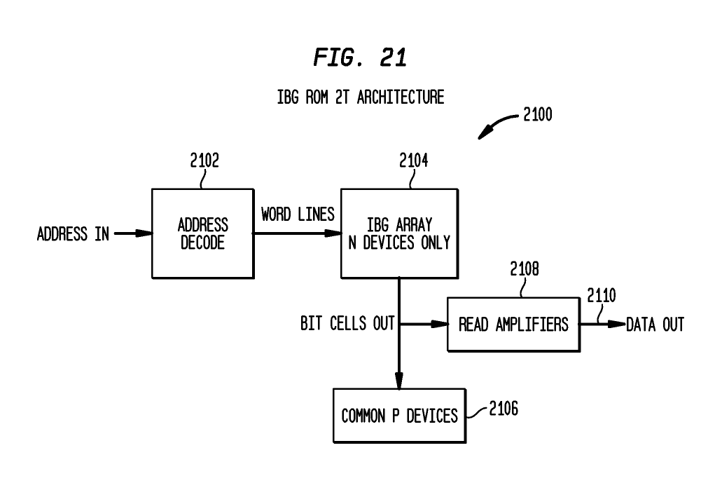

FIG. 20 shows a 2×2 array of a 2T IBG ROM 2000 in accordance with the present invention. The 2×2 IBG ROM includes four N channel transistors 2002, 2004, 2006 and 2008 and their associated pass transistors 2012, 2014, 2016 and 2018. The four N channel transistors 2002, 2004, 2006 and 2008 have output nodes 2003, 2005, 2007 and 2009. The N channel transistors 2002, 2004, 2006 and 2008 are selected to have device geometries and device characteristics, including doping characteristics, adapted to bias the output nodes 2003, 2005, 2007, and 2009 at predetermined voltage levels indicating a binary 1 or a predetermined voltage level indicating a binary 0 when the N channel transistors 2002, 2004, 2006 and 2008 is connected to a P channel device, described in greater detail below. The doping characteristic differences between a binary 1 and a binary 0 are too small to be detected by optical techniques. Transistors 2002 and 2004 are both part of a first word, and their pass transistors 2012 and 2014 are turned ON by a first word line 2020. Transistors 2006 and 2008 are both part of a second word, and their pass transistors 2016 and 2018 are turned ON by a second word line 2022. The output of pass transistors 2012 and 2016 are connected to a first data bus 2030 and the output of pass transistor 2014 and 2018 are connected to a second data bus 2032. When the word line 2020 is asserted the pass transistors 2012 and 2014 are turned ON and the pass transistors 2012 and 2014 pass the predetermined voltage levels of the output nodes 2003 and 2005 to the data buses 2030 and 2032. When the word line 2022 is asserted the pass transistors 2016 and 2018 are turned ON and the pass transistors 2016 and 2018 pass the predetermined voltage levels of the output nodes 2007 and 2008 to the data buses 2030 and 2032.

A first common P channel circuit 2040 is connected to the first data bus 2030 and operates as the common P channel for transistors 2002 and 2006, and a second common P channel circuit 2042 is connected to the second data bus 2032 and operates as the common P channel for transistors 2014 and 2018. The predetermined voltage level will only be present at the output nodes 2003 and 2005 when the pass transistors 2012 and 2014 are turned ON and thus connecting the common P channel circuit 2040 to the transistors 2002 and 2004 to provide the leakage current for the operation of the N channel transistors 2002 and 2004. Similarly, the predetermined voltage level will only be present at the output nodes 2007 and 2009 when the pass transistors 2016 and 2018 are turned ON and thus connecting the common P channel circuit 2042 to the transistors 2006 and 2008 to provide the leakage current for the operation of the N channel transistors 2006 and 2006.

FIG. 21 shows a functional block diagram 2100 of a 2T architecture ROM system in accordance with the present invention. An address decode 2102 unit receives the address to be read from an external system and decodes this address to select a word line which corresponds the word of data to be read from the IBG N channel device array 2104. Common P channel devices 2106 are connected to each data line output 2104. A read amplifier 2108 amplifies the word of data output to convert the word of data from voltage levels output the array 2104 to levels that correspond to logical “1” and logical “0” in digital logic circuits. The read amplifier transmits the amplified data on a data bus 2110.

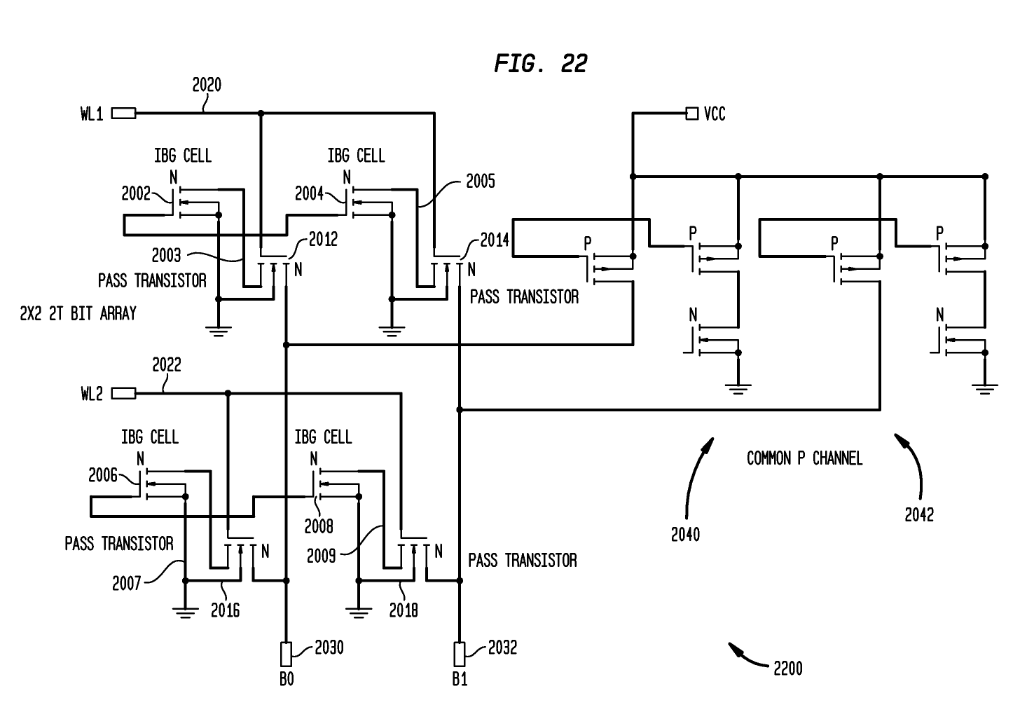

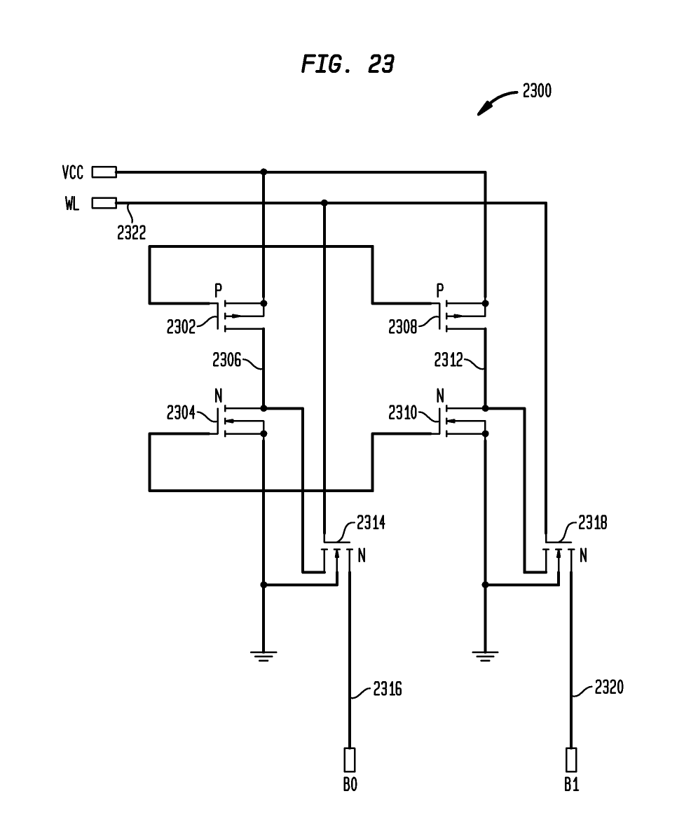

FIG. 22 shows an alternate embodiment of a 2T IBG ROM circuit 2200 in accordance with the present invention. In contrast to the 2T IBG ROM circuit 2000 shown in FIG. 20, the gates of the N channel IBG transistors 2002 and 2004, and the gates of the N channel IBG transistors 2006 and 2008, are connected in a bit-pair fashion. Connecting these N channel gates increases the gate capacitance and leakage current of the transistors 2002, 2004, 2006 and 2008 when compared to the 2T IBG ROM circuit 2000. This allows smaller geometry IBG cells having smaller geometry to operate properly and settle faster.

FIG. 23 shows 3 transistor (3T) IBG ROM bit-pair circuit 2300 in accordance with one aspect of the present invention. The 3T IBG ROM circuit 2300 includes a first transistor pair having a P channel transistor 2302 connected in series with an N channel transistor 2304 through an output node 2306. A second transistor pair has a P channel transistor 2308 connected in series with an N channel transistor 2310 through an output node 2312. The gate of transistor 2302 is connected to the gate of transistor 2308, allowing these devices to share leakage current. Similarly, the gate of transistor 2304 is connected to the gate of transistor 2310, allowing these devices to also share leakage current. The transistors 2302 and 2304 are selected to have a device geometries and device characteristics, including doping characteristics, adapted to bias the output node 2306 at a predetermined voltage level indicating a binary 1 or a predetermined voltage level indicating a binary 0. The doping characteristic differences between a binary 1 and a binary 0 are too small to be detected by optical techniques.

An N channel transistor 2314 is connected between the output node 2306 and a data bus 2316. An N channel transistor 2318 is connected between the output node 2312 and a data bus 2320. A word line 2322 is connect to the gate of the N channel transistor 2314 which operates as pass transistor and is turned ON by the word line 2322. The word line 2322 is also connected to the gate of the N channel transistor 2318 which operates as a pass transistor and is turned ON by the word line 2322. When the word line 2322 is asserted, the pass transistors 2314 and 2318 pass the predetermined voltage levels of the output nodes 2306 and 2312 to the data busses 2316 and 2320.

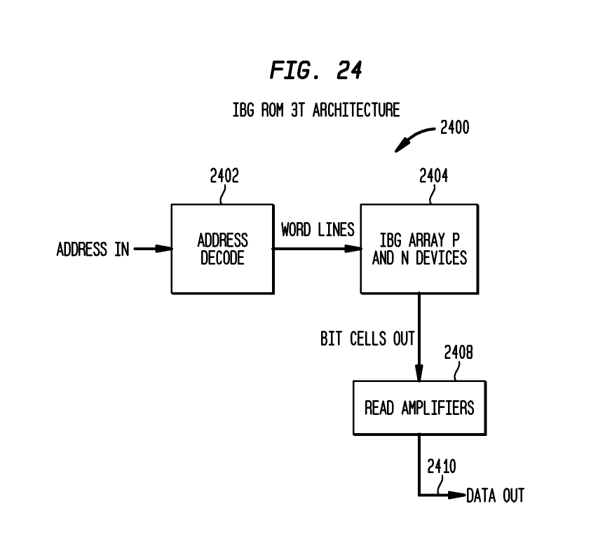

FIG. 24 shows a functional block diagram 2400 of a 3T architecture ROM system in accordance with the present invention. An address decode 2402 unit receives the address to be read from an external system and decodes this address to select a word line which corresponds the word of data to be read from the IBG P and N channel device array 2404. A read amplifier 2408 amplifies the word of data output to convert the word of data from voltage levels output the array 2104 to levels that correspond to logical “1” and logical “0” in digital logic circuits. The read amplifier transmits the amplified data on a data bus 2410.

In another aspect of the present invention, a security shield may be utilized with an array of IBG ROM circuits. An IBG ROM circuit array may include a top metal trace or run that is routed in a serpentine manner over a surface of the array to provide the ground (GND) connections for devices which comprise the array. For example, the security shield may be placed over the second metal layer 1805 of FIG. 18. Any attempt to reverse engineer the array which cuts the security shield will cause the IBG ROM circuits to fail, complicating any circuit measurements during operation. After being repaired, the cuts will exhibit increased DC resistance and thus limit the number of repairs which can be completed successfully.

In the imaging industry, there is a growing market for the remanufacture and refurbishing of various types of replaceable imaging cartridges such as toner cartridges, drum cartridges, inkjet cartridges, and the like. These imaging cartridges are used in imaging devices such as laser printers, xerographic copiers, inkjet printers, facsimile machines and the like, for example. Imaging cartridges, once spent, are unusable for their originally intended purpose. Without a refurbishing process these cartridges would simply be discarded, even though the cartridge itself may still have potential life. As a result, techniques have been developed specifically to address this issue. These processes may entail, for example, the disassembly of the various structures of the cartridge, replacing toner or ink, cleaning, adjusting or replacing any worn components and reassembling the imaging cartridge. For example if the imaging cartridge includes a drum or roller, such as an organic photo conductor (OPC) drum, that drum or roller may be replaced or refurbished.

Some toner cartridges may include a chip having a memory device which is used to store data related to the cartridge or the imaging device, such as a printer, for example. The imaging device may communicate with the chip using a direct contact method or a broadcast technique utilizing radio frequency (RF) communication. The imaging device, such as the printer, reads the data stored in the cartridge memory device to determine certain printing parameters and communicates information to the user. For example, the memory may store the model number of the imaging cartridge so that the printer may recognize the imaging cartridge as one which is compatible with that particular imaging device. Additionally, by way of example, the cartridge memory may store the number of pages that can be expected to be printed from the imaging cartridge during a life cycle of the imaging cartridge and other useful data. The imaging device may also write certain data to the memory device, such as an indication of the amount of toner remaining in the cartridge. Other data stored in the memory device may relate to the usage history of the toner cartridge.

This chip is typically mounted in a location, such as a slot, on the cartridge to allow for proper communication between the printer and the toner cartridge when the cartridge is installed in the printer. When the toner cartridge is being remanufactured, as described above, the chip provided by the original equipment manufacturer (OEM), such as Hewlett-Packard or Lexmark, may need to be replaced by a compatible chip developed by a third party. It is desirable to protect the circuit design of a chip for an imaging cartridge. Thus, an imaging cartridge chip which comprises one or more IBG devices, making is difficult to reverse engineer, would be highly advantageous.

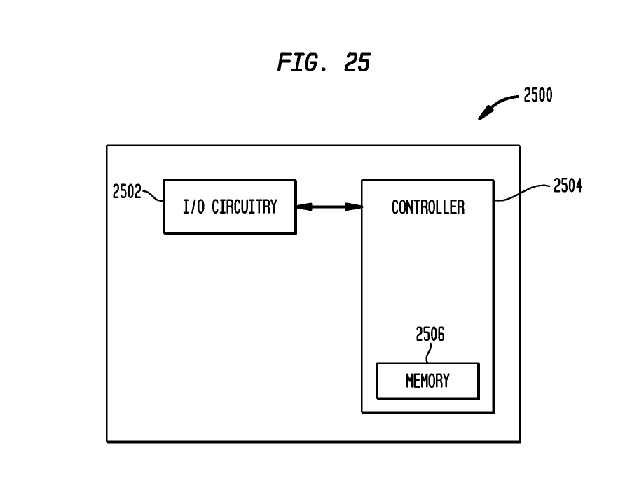

FIG. 25 shows a functional block diagram of an imaging cartridge chip 2500 in accordance with the present invention including one or more IBG devices described in greater detail in the present application. The imaging cartridge chip 2500 may suitably include input and output (I/O) interface circuitry 2502, a controller 2504, and a memory 2506. The I/O interface circuitry 2502 is communicatively connected to the controller 2504 and provides the appropriate electronic circuitry for the controller 2504 to communicate with an imaging device, such as a printer. As an example, for imaging devices which communicate utilizing radio frequency (RF), the I/O interface circuitry 102 may include a radio frequency (RF) antenna and circuitry, and for a direct wired connection to imaging devices the I/O interface circuitry 2502 may include one or more contact pads, or the like, and interface circuitry.

The controller 2504 controls the operation of the imaging cartridge chip 100 and provides a functional interface to the memory 2506, including controlling the reading of data from and the writing of data to the memory 2506 by the printer. The data read from or written to the imaging cartridge chip 2500 may include a printer type, cartridge serial number, the number of revolutions performed by the organic photo conductor (OPC) drum (drum count), the manufacturing date, number of pages printed (page count), percentage of toner remaining, yield (expected number of pages), color indicator, toner-out indicator, toner low indicator, virgin cartridge indicator (whether or not the cartridge has been remanufactured before), job count (number of pages printed and page type), and any other data or program instructions that may be stored on the memory 2506.

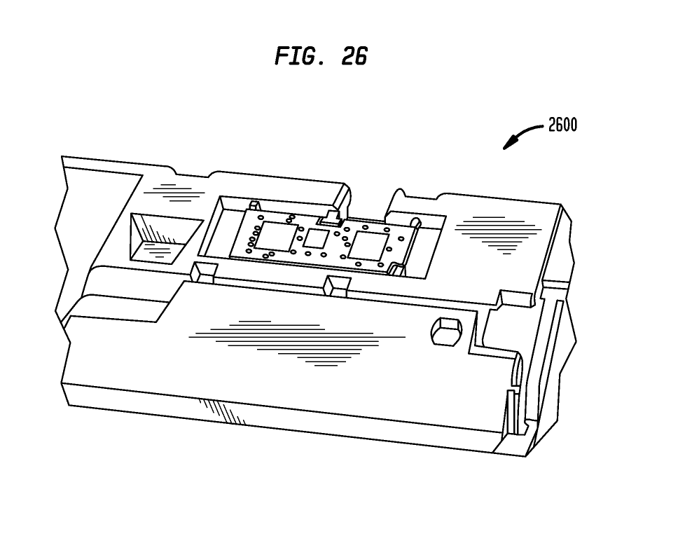

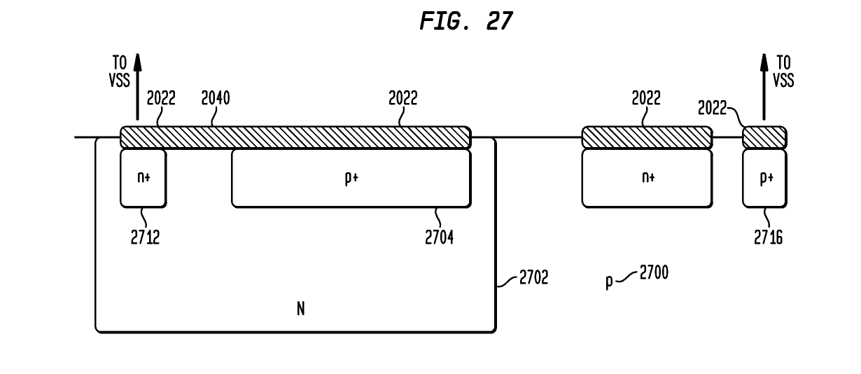

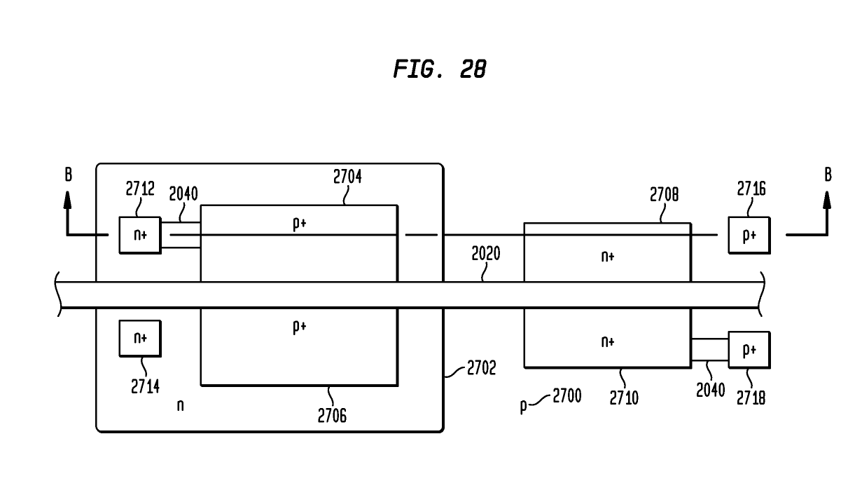

The controller 2504 may be suitably implemented as a custom or semi-custom integrated circuit, a programmable gate array, a microprocessor executing instructions from the memory 2506 or other memory, a microcontroller, or the like. Additionally, the controller 2504, the memory 2506 and/or the I/O interface circuitry 2502 may be separated or combined in one or more physical modules. These modules may be suitably mounted to a printed circuit board to form the imaging cartridge chip 2500. One or more of the controller 2504, the memory 2506, the I/O interface circuitry 2502 and any other circuits may be implemented using one or more IBG devices described in detail herein to protect the operation of the circuit from reverse engineering. FIG. 26 shows a perspective view of an exemplary embodiment of the imaging cartridge chip 2500 installed on an imaging cartridge 2600 in accordance with the present invention.

FIGS. 27 and 28 show an alternate embodiment of an IBG device in accordance with the present invention which may be suitably implanted in an imaging cartridge chip, such as the imaging cartridge chip described above. FIG. 27 shows a side sectional view of a typical CMOS pair. FIG. 28 shows a top plan view of the typical CMOS pair. In a P-substrate 2700 an N-well 2702 is formed. In N-well 2702 is a p+ source/drain 2704 and p+ source/drain 2706 formed via implantation. In P-substrate 2700 there is also a n+ source/drain 2708 and a n+ source/drain 2710 formed by implantation. There are also n+ regions 2712 and 2714 formed by implantation for connection to a Vcc source and p+ regions 2716 and 2718 formed by implantation for connection to a Vss source. Polysilicon gate 2720 creates a channel between any desired source and drain to be formed. Silicide layer 2722 (which is shown in exaggerated thickness proportion for illustration purposes and is shown “eating into” the substrate surface) is formed over the n+ regions 2712 and 2714, p+ regions 2716 and 2718, p+ source/drains 2704 and 2706, and n+ source/drains 2708 and 2710. In accordance with the present invention, an IBG device is formed by including a selected silicide layer 2740 interconnecting the n+ region 2712 and p+ source/drain 2704. This silicide layer 2740 which merges with silicide layer 2722 over n+ region 2017 and p+ source/drain 2704 is formed at the same time as silicide layer 2722 is formed. One or more other silicide layers could be used to inter connect other or all active areas, such as between n+ region 2710 and p+ region 2718, as would be determined by the circuit design components needing interconnection and which the designer would prefer having camouflaged. The extent of the silicide layer 2740 may be selected by the designer as desired such that standard upper layer interconnections are replaced by the silicide layer interconnections to thwart potential reverse engineering efforts. The silicide layer 2740 may thin, such as 100 Angstroms, and it is thus difficult to detect any connections made by silicide layer 2740. In a preferred embodiment, the silicide layer may be formed over at least one active area of the circuit active areas and over a selected substrate area for interconnecting the active area with another area through the silicide area. Additionally, the area silicide layer may be formed over at least a first active layer and over at least a second active layer for interconnecting the first active and the second active layer through the silicide.

In another aspect of the present invention, an IBG circuit provides a camouflaged digital IC, and a fabrication method for the IC, that is very difficult to reverse engineer, can be implemented without any additional fabrication steps and is compatible with computer aided design (CAD) systems that allow many different kinds of logic circuits to be constructed with ease. To achieve these goals, the size and internal geometry of the transistors within each of the cells are made the same for the same transistor type, different logic cells have their transistors arranged in substantially the same spatial pattern so that the logic functions are not discernible from the transistor patterns, and the transistors are collectively arranged in a uniform array on the substrate so that boundaries between different logic cells are similarly not discernible. Electrically conductive, heavily doped implant interconnections that are difficult for a reverse engineer to detect provide interconnections among the transistors within each cell, with the pattern of interconnections determining the cell's logic function. A uniform pattern of interconnections among all of the transistors on the substrate is preferably provided, with different logic functions implemented by interrupting some of the interconnections to make them apparent (they appear to be conductive connections but are actually non-conductive) by the addition of opposite conductivity channel stop implants. The channel stops are substantially shorter than the interconnections which they interrupt, preferably with a dimension equal approximately to the minimum feature size of the IC. To the extent the interconnections could be discerned by a reverse engineer, they would all look the same because the channel stops would not be detected, thus enhancing the circuit camouflage. Reverse engineering is further inhibited by providing a uniform pattern of metal leads over the transistor array. A uniform pattern of heavily doped implant taps are made to the various transistors to connect with the leads. Some of the taps are made apparent by blocking them with channel stops similar to those employed in the apparent intertransistor connections. A reverse engineer will thus be unable to either determine boundaries between different cells, or to identify different cell types, from either the metallization or the tap patterns. The metallization is preferably implemented in multiple layers, with the upper layers shading connections between a lower layer and the underlying IC. Such a camouflaged circuit is preferably fabricated by implanting the interconnections and the portions of the transistors which have the same conductivity at the same time, and also implanting the channel stops and the portions of the transistors which have the same conductivity as the channel stops at the same time.

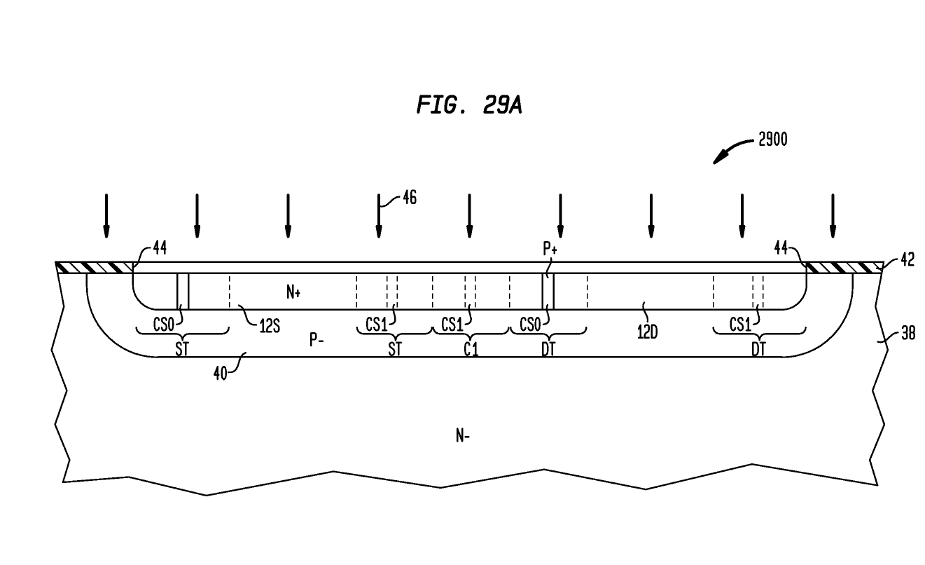

FIGS. 29A and 29B show cross sectional views of such an IBG fabrication 2900 that illustrates the transistor source/drain regions and associated implanted interconnects, including channel stops which make some of the interconnects apparent rather than functional. The devices are formed in a semiconductor 38 that for illustrative purposes is silicon, but can be some other desired semiconductive material. With substrate 38 illustrated as having an n− doping, a somewhat more heavily doped p− well 40 is formed. An oxide mask 42 is laid down over the substrate with openings at the desired locations for the sources and drains. In the case of an n-channel FET 12 whose source 12S and drain 12D may be interconnected by means of an ion implantation in accordance with the invention, a single continuous mask opening 44 is provided to implant the drain 12D, the source 12S, the outer and inner source and drain taps ST and DT, and the connector C1. The implantation is then performed, preferably with a flood beam (indicated by numeral 46) of suitable n-dopant ions such as arsenic. The unused channel stop sites CS1 are left with the same doping conductivity as their respective taps and connectors, while the active channel stops CSO are implanted to the opposite conductivity. This can be done by providing a mask over the CSO sites during the implantation of the source and drain and implanting the channel stops during the implantation of the p-channel transistors, or by implanting the channel stops n+ along with the rest of the n-channel transistors and then (or previously) performing a double-dose p+ implant that is restricted to the channel stops. The implantation can be performed in the same manner as prior unsecured processes, the only difference being that the implant is now done through a larger opening in each mask that includes the implanted taps and connectors as well as the FET sources and drains, but excludes the channel stops. As in conventional processing, a separate implant mask 48 is used for the p-channel devices. A single continuous opening 50 is provided in the mask for the taps and connectors and the transistor elements which they connect; these are illustrated as p-channel FET source 2S, drain 2D, drain taps DT, source taps ST and connector C1. Implantation is preferably performed with a flood beam, indicated by numeral 52, of a suitable p-type dopant such as boron. No differences in processing time or techniques are required, and the operator need not even know that the mask provides for circuit security. The circuits are then completed in a conventional manner, with threshold implants made into the FET channels to set the transistor characteristics. A field oxide is laid down as usual, and polysilicon is then deposited and doped either by diffusion or ion implantation to form the channels and the interconnects. A dielectric is next deposited and metallization layers added to establish inputs, outputs, bias line and any necessary cell linkages. Finally, an overglass or other suitable dielectric coating is laid down over the entire chip. Since the only required change in the fabrication process need be for a modification in the openings of the ion implantation masks, a new set of standard masks with the modified openings could be provided and used as standard elements of the circuit design process. This makes the invention particularly suitable for CAD systems, with the designer simply selecting a desired secure logic gate design from a library of such gates.

In another aspect of the present invention, a logical building block and method of using the building block to design a logic cell library for IBG CMOS ASICs is disclosed. Different logic gates, built with the same building block as described below, will have the same schematics of transistor connection and also the same physical layout so that they appear to be physically identical under optical or electron microscopy. An ASIC designed from a library of such logic cells is strongly resistant to a reverse engineering attempt.

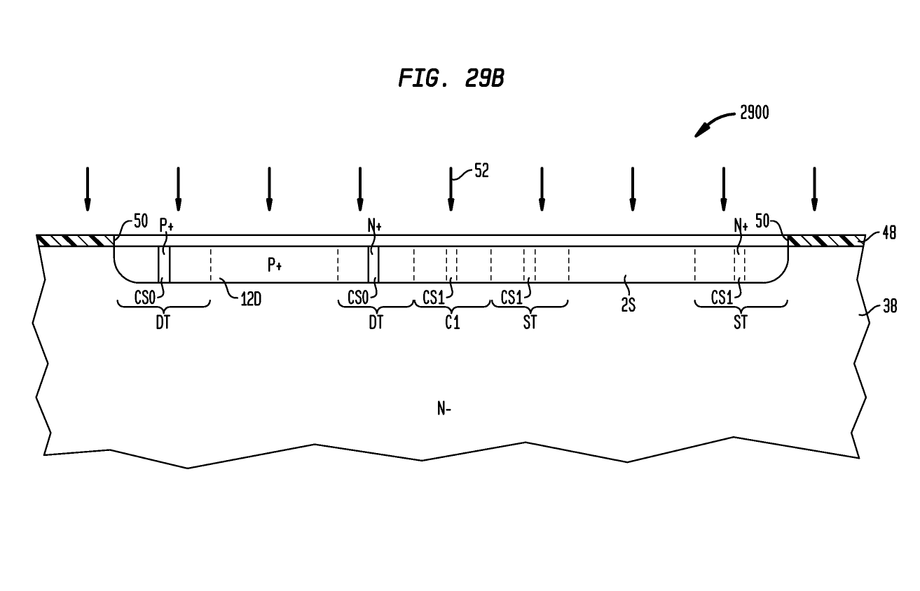

FIG. 30 illustrates an example of how IBG bit content can be programmed to change the logic function of an exemplary basic logic block 3020 in accordance with one aspect of the present invention. The operation of basic logic block 3020 would be readily understood by one of ordinary skill in the art and will not be described in detail. Two camouflage connectors 3031, 3032 are used in FIG. 30 connecting to the input C of the basic logic block 3020. IBG camouflage connectors 3031 and 3032 are a structure in CMOS technology that can be programmed to be either a connection or isolation but is very difficult to detect by reverse engineering. The IBG camouflage connector includes a structure in CMOS technology that can be either a connection or isolation, and without any obvious imaging difference between the connection and isolation of such a structure when exposed to a reverse engineering attack.

In FIG. 30, one IBG camouflage connector 3031 connects input C to the node labeled as C1, the other IBG camouflage connector 3032 is connected between input C and node labeled as C2. Nodes C1 and C2 can be driven by supply voltages Vdd, Vss, or by other active output signals from other logic cells, or even by the logic block's own output Z as a feedback signal. When the top camouflage connector 3032 is programmed to be a connection with node C2 connected to Vdd, while the bottom camouflage connector 3031 is programmed to be in isolation, input C will receive a logic state of ‘1’ and the logic block performs as an ‘OR’ gate of inputs A and B. Node C1 in this case can be connected to any signal since the bottom camouflage connector 31 is isolated.

If the top camouflage connector 3032 is programmed to be isolated, while the bottom camouflage connector 3031 is programmed to be a connector with node C1 connected to Vss, the logic state at input C is ‘0’ and the logic block performs the logic function of ‘A AND B bar’ (Z=A B). Node C2 in this case can be connected to any signal since the top camouflage connector is isolated.

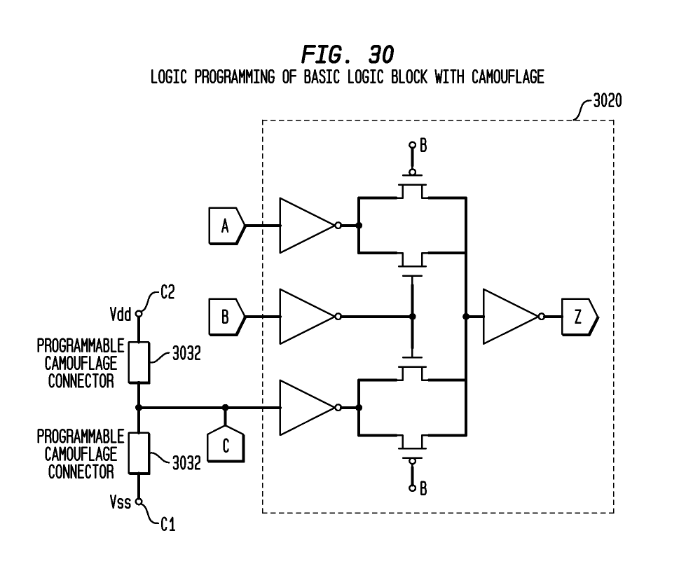

An example of an IBG camouflage connector, such as connector 3031 for example, is shown in FIG. 31. The top drawing in FIG. 31 shows a connection implemented with an N-type extension implant, also called an NLDD (N-type Lightly Doped Drain) implant. To make such a camouflage connector, a silicide window is opened over a PN junction in an active silicon area to avoid a direct short of the PN junction through Silicide. Silicide, sometimes called Salicide (Self-aligned Silicide), is a metallic silicon compound formed by depositing a thin layer of metal (e.g. Titanium) on the silicon surface for the purpose of reducing the sheet resistance of the silicon implanted regions. When the center part of this PN junction with silicide window is implanted with NLDD implant, the two terminals of the PN junction will be shorted, due to the conduction path from N+ region to NLDD region and further from NLDD region to P+ region via the silicide on top. The NLDD implant is one of the standard implants in the CMOS fabrication process. It is a lighter doped implant compared to the source and drain N+/P+ implants. Its function is to reduce the short channel effect of the CMOS N-type devices. The P-type extension, or PLDD implant, is the similar kind of implant for the P-type device in CMOS fabrication. Switching the NLDD in the top structure of FIG. 31 to PLDD implant will turn the structure into isolation as a reverse biased PN junction. This is shown in the bottom drawing of FIG. 31. The presence of field oxide (F.O.) is to isolate the camouflage connectors from other active circuits. Since NLDD and PLDD implants are lighter in concentration and shallower in depth compared to the source and drain N+/P+ implants, reverse engineers will find them difficult to differentiate when they are located next to the heavy doped N+/P+ region. It is favorable to use as many as possible of the different techniques to implement camouflage connectors, because the greater the variety of camouflage connectors, the more difficult it will be to reverse engineer an ASIC designed with these camouflage connectors.

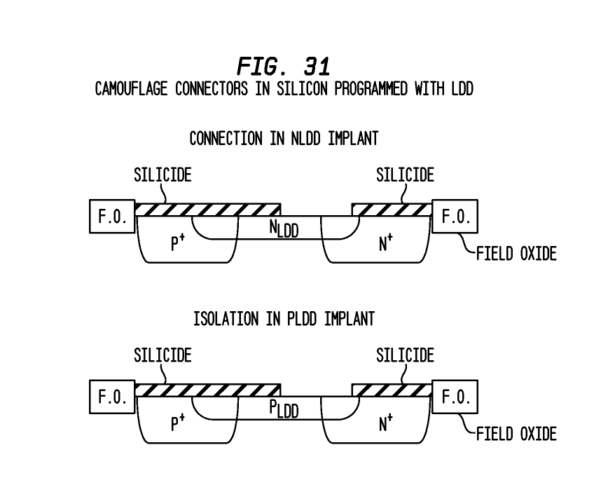

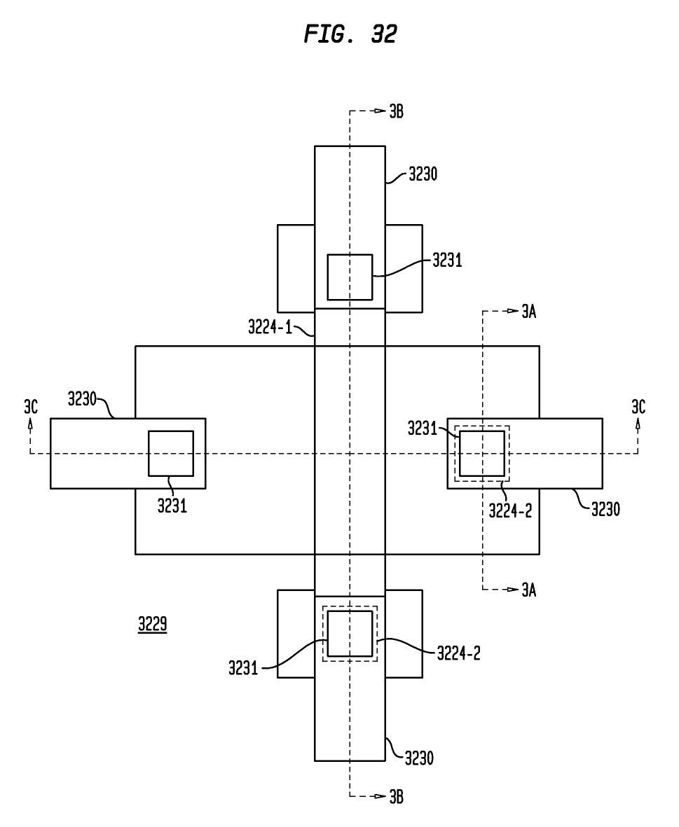

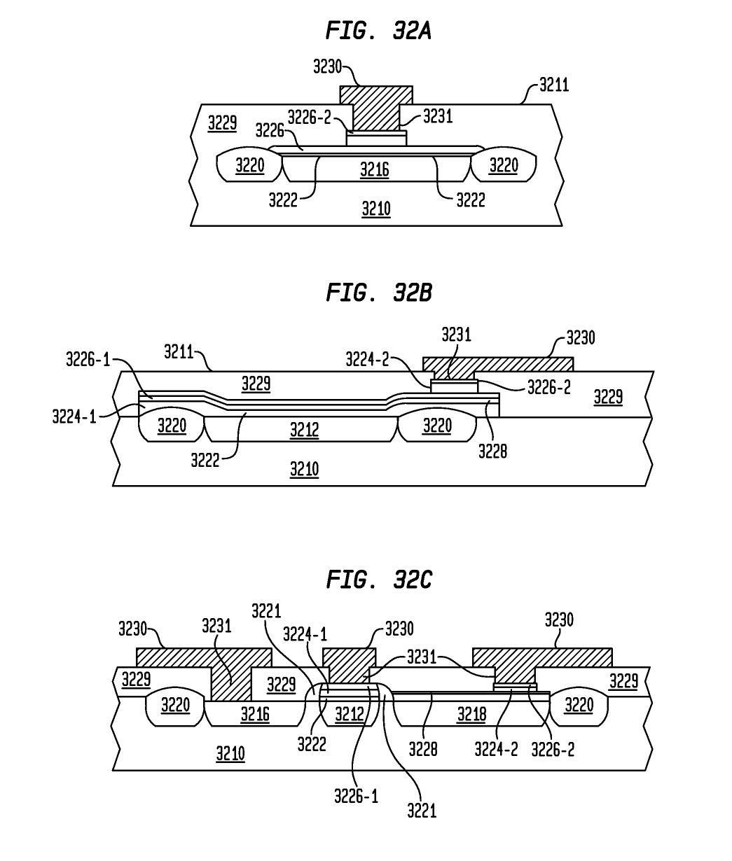

In another aspect of the present invention, an IBG integrated circuit structure is formed by a plurality of layers of material having controlled outlines and controlled thicknesses. A layer of dielectric material of a controlled thickness is disposed among said plurality of layers to thereby render the integrated circuit structure intentionally inoperable. Such a technique will make reverse engineering even more difficult and, in particular, will force the reverse engineer to study the possible silicon-to-gate poly lines very carefully, to see if they are in fact real. It is believed that this will make the reverse engineer's efforts all the more difficult by making it very time consuming in order to reverse engineer a chip employing the present invention and perhaps making it exceedingly impractical, if not impossible, to reverse engineer a chip employing the present invention as described below in relation to FIGS. 32-32C. FIG. 32 is a plan view of the semiconductor device which appears to be a field effect transistor (FET). However, as can be seen from the cross-sectional views depicted in FIGS. 32A, 32B, and 32C the semiconductor device is a pseudo-transistor. FIG. 32A depicts how a contact can be intentionally “broken” by the present invention to form the pseudo-transistor. Similarly, FIG. 32B shows how the gate structure can be intentionally “broken” by the present invention to form the pseudo-transistor. FIG. 32C is a cross-sectional of both the gate region 3212 and active regions 3216, 3218, the contact to the active region 3218 being intentionally “broken” by the present invention to form the pseudo-transistor. One skilled in the art will appreciate that although these figures depict enhancement mode devices, the pseudo-transistor may also be a depletion mode device. Where the gate, source or drain contacts are intentionally “broken” by the present invention. In the case of a depletion mode transistor, if the gate contact is “broken”, the device will be “ON” when a nominal voltage is applied to the control electrode. If the source or drain contact is “broken”, the pseudo-depletion mode transistor will essentially be “OFF” for a nominal voltage applied to the control electrode.

A double-poly semiconductor process preferably includes two layers of polysilicon 3224-1, 3224-2 and may also have two layers of salicide 3226-1, 3226-2. Double polysilicon processing may be used to arrive at the structures shown in FIGS. 32, 32A, 32B and 32C.

FIG. 32 shows a pseudo-FET transistor in plan view, but those skilled in the art will appreciate that the metal contact of a bipolar transistor is very similar to the source/drain contact depicted. FIG. 32A is a side elevation view of the pseudo-transistor in connection with what appears to the reverse engineer (viewing from the top, see FIG. 32) as an active area metal layer 3230, 3231 of a CMOS FET. Alternatively, the device could be a vertical bipolar transistor in which case the metal layer 3320, 3231 that the reverse engineer sees could be an emitter contact. As depicted in FIG. 32A, for a CMOS structure, an active region 3218 may be formed in a conventional manner using field oxide 3220 as the region boundary. The active region 3218 is implanted through gate oxide 3222 (see FIG. 32C), which is later stripped away from over the active regions and optionally replaced with the silicide metal which is then sintered, producing a silicide layer 3226-1. Next, a dielectric layer 3228 is deposited. In the preferred embodiment, the dielectric layer is a silicon dioxide layer 3228. Additionally, a polysilicon layer 3224-2 may be deposited over the silicon dioxide layer 3228. Polysilicon layer 3224-2 is preferably the second polysilicon layer in a double polysilicon process. Optional silicide layer 3226-2 is then formed over the polysilicon layer 3224-2. A second silicon dioxide layer 3229 is deposited and etched to allow a metal layer, including metal plug 3231 and metal contact 3230 to be formed over the optional silicide layer 3226-2 or in contact with polysilicon layer 3224-2 (if no suicide layer 3226-2 is utilized). The oxide layer 3228 and oxide layer 3229 are preferably comprised of the same material (possibly with different densities) and as such are indistinguishable from each other to the reverse engineer when placed on top of each other.

Different masks are used in the formation of the polysilicon layer 3224-2 and the metal plug 3231. In order to maintain alignment between the polysilicon layer 3224-2 and the metal plug 3231, a cross-section of the polysilicon layer 3224-2 in a direction parallel to the major surface 3211 of the semiconductor substrate 3210 is preferably designed to be essentially the same size, within process alignment tolerances, as a cross-section of the metal plug 3231 taken in the same direction. As such, the polysilicon layer 3224-2 is at least partially hidden by the metal plug 3231. In FIGS. 32, 32A, 32B and 32C, the polysilicon layer 3224-2 is depicted as being much larger than metal plug 3231; however, these figures are exaggerated simply for clarity. Preferably, the polysilicon layer 3224-2 is designed to ensure that a cross-section of metal plug 3231 is aligned with a cross-section of polysilicon layer 3224-2, or a cross-section of optional silicide layer 3226-2 if used, yet small enough to be very difficult to view under a microscope. Further, the bottom of metal plug 3231 is preferably completely in contact with the polysilicon layer 3224-2, or optional silicide layer 3226-2 if used.

The reverse engineer cannot easily obtain an elevation view. In fact, the typical manner in which the reverse engineer would obtain the elevation views would be via individual cross-sectional scanning electron micrographs taken at each possible contact or non-contact. The procedure of taking micrographs at each possible contact or non-contact is prohibitively time consuming and expensive. The reverse engineer, when looking from the top, will see the top of the metal contact 3230. The contact-defeating layer of oxide 3228 with polysilicon layer 3224-2 and optional suicide layer 3226-2 will be at least partially hidden by a feature of the circuit structure, i.e. metal contact 3230 and metal plug 3231.

The reverse engineering process usually, involves delayering the semiconductor device to remove the layers down to the silicon substrate 3210, and then viewing the semiconductor device from a direction normal to the major surface 3211 of the silicon substrate 3210. During this process, the reverse engineer will remove the traces of the oxide layer 3228 which is used in the present invention to disable the contact.

Further, the reverse engineer may chose a more costly method of removing only the metal contact 3230 from the semiconductor area. A cross-section of polysilicon layer 3224-2 is preferably essentially the same size, within process alignment tolerances, as a cross-section of metal plug 3231. The oxide layers 3228, 3229 are practically transparent, and the thicknesses of the optional silicide layer 3226-2 and the polysilicon layer 3224-2 are small. A typical thickness of the optional silicide layer 3226-2 is 100-200 angstroms, and a typical thickness of the polysilicon layer 3224-2 is 2500-3500 angstroms. Thus, the reverse engineer when viewing the device from the top will assume that the metal plug 3231 is in contact with the silicide layer 3226-1, thereby assuming incorrectly that the device is operable. Further, when the optional silicide layer 3226-2 is used, the reverse engineer may be further confused when looking at the device once the metal plug 3231 has been removed. Upon viewing the shiny reside left by the suicide layer 3226-2, the reverse engineer will incorrectly assume that the shiny reside is left over by the metal plug 3231. Thus, the reverse engineer will again incorrectly assume that the contact was operational.

FIG. 32B is a side elevation view of a gate contact of the pseudo-transistor of FIG. 32. As can be seen from FIG. 32, the view of FIG. 32B, which is taken along section line 32B-32B, is through a gate oxide layer 3222, through a first polysilicon layer 3224-1 and through a first a silicide layer 3226-1 which are formed over the field oxide region 3220 and gate region 3212 in the semiconductor substrate 3210 (typically silicon) between active regions 3216 and 3218 (see FIG. 323C). The first polysilicon layer 3224-1 would act as a conductive layer which influences conduction through the gate region 3212 by an application of control voltages, if this device functioned normally. Active regions 3216, 3218 and 3212, gate oxide 3222, the first polysilicon layer 3224-1, and the first suicide layer 3226-1 are formed using conventional processing techniques. For a normally functioning device, a control electrode formed by metal layer 3230, 3231 would be in contact with the layer of silicide layer 3226-1 over field oxide 3220. The silicide layer 3226-1 would then act as a control layer for a normally functioning device. To form a pseudo-transistor, at least one dielectric layer, for example a layer of oxide 3228, is deposited. Next, a second polysilicon layer 3224-2 and an optional second silicide layer 3226-2 are deposited over the oxide layer 3228. The layer of silicide 3226-2 depicted between the polysilicon layer 3224-2 and metal plug 3231 may be omitted in some fabrication processes, since some double-polysilicon processing techniques utilize only one layer of silicide (when such processing techniques are used only one layer of silicide 3226-1 or 3226-2 would be used). In either case, the normal functioning of the gate is inhibited by the layer of oxide 3228.

A cross-section of the second polysilicon layer 3224-2 in a direction parallel to the normal surface 3211 of the semiconductor substrate 3210 is preferably essentially the same size, within process alignment tolerances, as a cross-section of metal plug 3231 taken in the same direction. As such, the second polysilicon layer 3224-2 is partially hidden by metal plug 3231. In FIGS. 32, 32A, 32B and 32C, the polysilicon layer 3224-2 is depicted as being much larger than metal plug 3231; however, these figures are exaggerated simply for clarity. Preferably, the polysilicon layer 3224-2 is designed to ensure that the cross-section of metal plug 3231 is completely aligned with the cross-section of polysilicon layer 3224-2, or a cross-section of optional silicide layer 3226-2 if used, yet small enough to be very difficult to view under a microscope. Further, the bottom of metal plug 3231 is preferably completely in contact with the polysilicon layer 3224-2, or the optional silicide layer 3226-2 if used.

The added oxide layer 3228 and polysilicon layer 3224-2 are placed such that they occur at the normal place for the metal to polysilicon contact to occur as seen from a plan view. The placement provides for the metal layer 3230, 3231 to at least partially hide the added oxide layer 3228 and/or polysilicon layer 3224-2, so that the layout appears normal to the reverse engineer. The reverse engineer will etch off the metal layer 3230, 3231 and see the polysilicon layer 3224-2 and possible reside from optional silicide layer 3226-2, if used. Upon seeing the shiny reside from optional silicide layer 3226-2 the reverse engineer may incorrectly assume that the shiny reside is from the metal plug 3231. A reverse engineer would not have any reason to believe that the contact was not being made to polysilicon layer 3224-1 or optional silicide layer 3226-1. Further, when optional suicide layer 3226-2 is not used, the small thicknesses of oxide layer 3228 and polysilicon layer 3226-2 are not clearly seen when viewing the contact from a direction normal to the major surface 3211 of the silicon substrate 3210, and thus the reverse engineer will conclude he or she is seeing a normal, functional polysilicon gate FET transistor.

In use, the reverse engineering protection techniques of FIG. 32A, FIG. 32B and/or FIG. 32C need only be used sparingly, but are preferably used in combination with other reverse engineering techniques such as those discussed above under the subtitle “Related Art.” The basic object of these related techniques and the techniques disclosed herein is to make it so time consuming to figure out how a circuit is implemented (so that it can be successfully replicated), that the reverse engineer is thwarted in his or her endeavors. Thus, for the many thousands of devices in a modern IC, only a small fraction of those will employ the pseudo-transistors described herein and depicted in FIGS. 32A, 32B and 32C to camouflage the circuit. Therefore, unless the reverse engineer is able to determine these pseudo-transistors, the resulting circuit determined by the reverse engineer will be incorrect.

Additionally, the pseudo-transistors are preferably used not to completely disable a multiple transistor circuit in which they are used, but rather to cause the circuit to function in an unexpected or non-intuitive manner. For example, what appears to be an OR gate to the reverse engineer might really function as an AND gate. Or what appears as an inverting input might really be non-inverting. The possibilities are almost endless and are almost sure to cause the reverse engineer so much grief that he or she gives up as opposed to pressing forward to discover how to reverse engineer the integrated circuit device on which these techniques are utilized.

Also, when the reverse engineer etches away the metal 3230, 3231, he or she should preferably “see” the normally expected layer whether or not a contact is blocked according to the present invention. Thus, if the reverse engineer expects to see suicide after etching away metal, that is what he or she should see even when the contact is blocked. If he or she expects to see polysilicon after etching away metal, that is what he or she should see even when the contact is blocked.

In another aspect, an IBG circuit in accordance with the present invention makes use of an artifact edge of a silicide layer that a reverse engineer might see when reverse engineering devices manufactured with other reverse engineering detection prevention techniques. More specifically, a conductive layer block mask is used during the manufacturing of semiconductor devices in order to further confuse a reverse engineer.

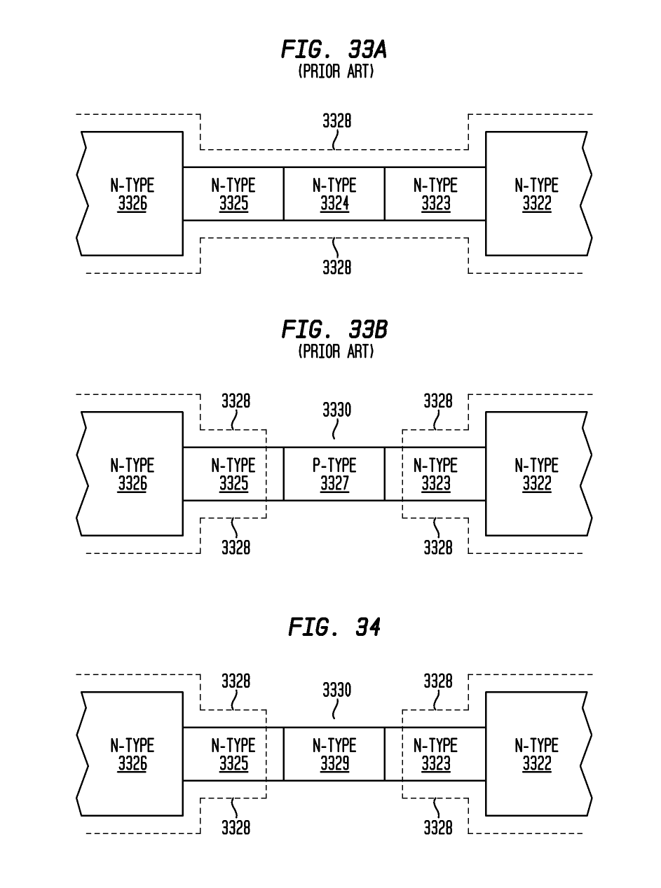

In a reverse engineering detection prevention technique, described above, channel block structures are used to confuse the reverse engineer. As shown in FIG. 33B, the channel block structure 3327 has a different dopant type than the channel areas 3323, 3325 and has an interruption 3330 in the overlying silicide. After using a reverse engineering process, such as CMP, the artifact edges 3328 of a silicide layer may reveal to the reverse engineer that a channel block structure 3324, 3327 has been used to interrupt the electrical connection between two channel areas 3323, 3325, as can be seen from comparing FIGS. 33A and 33B. The type of dopant used in the channel areas and the channel block structure is not readily available to the reverse engineer during most reverse engineering processes. Thus, the reverse engineer is forced to rely upon other methods, such as the artifact edges 3328 of a silicide layer, to determine if the conductive channel has a channel block in it.

FIG. 34 depicts artifact edges 3328 of a silicide layer of an IBG device manufactured in accordance with the present invention. A silicide block mask is preferably modified to prevent a silicide layer from completely covering a pseudo channel block structure 3329. Channel block structure 3329 is of the same conductivity type as channel areas 3323, 3325; therefore, the presence or absence of a silicide layer connecting the channel areas 3323, 3325 does not have an impact on the electrical conductivity through the channel. However, by modifying the silicide block mask to prevent a silicide layer from completely covering the pseudo channel block structure 3329, the artifact edge 3328 with interruption 3330 appears to the reverse engineer to indicate that the channel is not electrically connected, i.e. the artifact edges 3328 of FIG. 34 are identical to the artifact edges 3328 of FIG. 33B. Thus, the reverse engineer, when viewing the artifact edge 28, would leap to an incorrect assumption as to the connectivity of the underlying channel.

In order to further camouflage the circuit, the dopant type used in channel block structure 3329 may be created at the same time Lightly Doped Drains (LDD) are created. Thus, even using stain and etch processes, the reverse engineer will have a much more difficult time discerning the difference between the two types of implants, N-type versus P-type, vis-a-vis the much higher dose of the source/drain implants 3322, 3326. Further, by creating the pseudo channel block structure 3329 with the LDD processes, the channel block structure 3329 can be made smaller in dimensions because of breakdown considerations.

In the preferred method of manufacturing the present invention, the design rules of a semiconductor chip manufacturer are modified to allow implanted regions that are not silicided. In addition, the design rules may also be modified to allow for channel block structure 3329 to be small and lightly doped (through the use of LDD implants) to further prevent detection by the reverse engineer.

In modifying the design rules, it is important to ensure that the artifact edges of an actual conducting channel, as shown in FIG. 34, match the placement of the artifact edges of a non-conducting channel, as shown in FIG. 33B. For illustration purposes, the artifact edges 3328 in FIG. 33B match the artifact edges 3328 of FIG. 34. As one skilled in the art will appreciate, the artifact edges 3328 do not have to be located as specifically shown in FIG. 33B or 34. Instead, the artifact edges may appear almost anywhere along the channel. However, it is important that (1) the silicide layer does not provide an electrical connection (i.e. that the silicide layer does not completely cover channels with an intentional block or a pseudo block therein), and (2) that the artifact edges 3328 for an electrical connection (i.e. a true connection) are relatively the same as the artifact edges 3328 for a non-electrical connection (i.e. a false connection). As such, while it may be advisable to include conducting and non-conducting channels of the types shown in FIGS. 33A, 33B and 34 all on a single integrated circuit device, it is the use of a mixture of channels of the types shown and described with reference to FIGS. 33B and 34 that will keep the reverse engineer at bay.

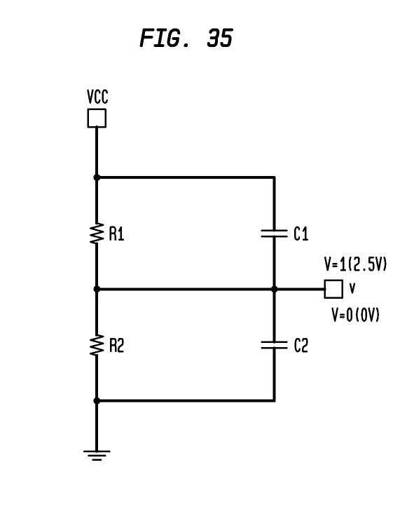

In another aspect of the present invention, IBG circuitry may comprise other passive devices, such as capacitors. As an ideal capacitor blocks all current, this renders an ideal capacitor divider's output to an unknown state for a DC power source. The DC equation for a Capacitor is i (current)=C (Capacitance)*dV/dT (Rate of Voltage Change). Unless the input voltage is changing, an ideal capacitor can't be used to define voltages that can be used in IBG circuitry. Thus voltages in a circuit will change initially when powering the circuit. In addition, all capacitors have some amount of leakage current which may modeled by resistors. See FIG. 35, which shows actual capacitors modeled as ideal capacitors C1 and C2 in parallel with resistors R1 and R2.

In the case of an IBG circuit having capacitors, these capacitors may act as a non-volatile voltage storage devices based on the initial voltage change when power is supplied to the circuit. The capacitance values will determine the initial voltage levels and the resistors, which model the leakage of real capacitors, will determine how this voltage level decays. After power (Vcc) is supplied to the voltage divider circuit of FIG. 35, the node V is initially charged primarily through the capacitor divider if the resistance values of R1 and R2 are large. Over a period of time, the DC voltage level of the output V will decay to the voltage value determined by R1 and R2. As long as R1 and R2 are large the amount of time may be very large, on the order of years. In this case the capacitance values then determine the DC level of V.

Capacitance values are physically determined by the area (usually metal), the spacing between capacitor nodes (dielectric), and the dielectric constant. In a MOS process the metal geometry, dielectric thickness, or dielectric material may be varied to change capacitance values. Of these the dielectric material would be extremely difficult to determine for reverse engineering purposes. Thus capacitors, such as the capacitor pair of FIG. 35, may be biased to function as an IBG circuit and impede the reverse engineer.

In another aspect of the present invention, IBG devices may be used to provide for secure digital communication between multiple entities. Many transactions between two devices, such as that which occurs during commerce transactions via the internet for example, require secure data transfers so that credit card, password, bank account or other sensitive information can't be intercepted and used illegally. Secure data transfers may also be used to authenticate the identity of a device or a person. The process of coding plaintext to create cipher text is called encryption and the process of decoding cipher text to produce the plain text is called decryption. In order to secure a data transaction, encryption is used on the communication link between the two communicating entities by utilizing algorithms which allow the plaintext data to be encrypted by the transmitting entity and decrypted by the receiving entity. Additionally, encryption and decryption can be used to authenticate a message or device, such as a printing device.

Traditionally, ciphers have used information contained in secret decoding keys to encrypt and decrypt messages. Modern systems of electronic cryptography use bit strings known as digital keys and mathematical algorithms to encrypt and decrypt information. There are two types of encryption: symmetric key (private key) encryption and asymmetric key (public key) encryption. Symmetric key and private key encryption are used, often in conjunction, to provide a variety of security functions for network and information security.

Symmetric key encryption algorithms use the same key for both encrypting and decrypting information. A symmetric key is also called a private key because it is kept as a shared secret between the sender and receiver of the information. As the encryption and decryption algorithms are typically not a secret, the symmetric key must be kept secret in order to protect the information.

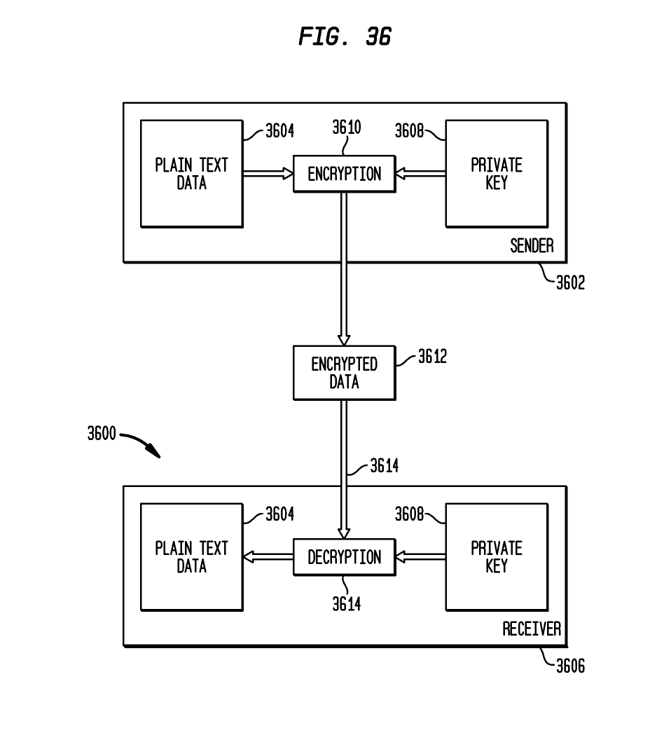

FIG. 36 shows a block diagram of a private key system 3600, in accordance with an exemplary embodiment. The private key system 3600 allows a sender 3602 to send plaintext data 3604 to a receiver 3606 with the knowledge that if intercepted, no one other than the receiver can view plaintext data 3604. The sender 3602 encrypts the plaintext data 3604 using a private key 3608 that is not publically known. Private key 3608 is used with an encryption algorithm 3610 to securely encrypt plaintext data 3604 into encrypted data 3612. The encryption algorithm 3610 is typically not a secret. Plaintext data 3604 may be text, such as an electronic mail message (e-mail), or any other digital information such as a photograph, or simple binary data. Once encrypted, encrypted data 3612 may be sent on a network 3614, such as the Internet or any other communication link, with confidence that only receiver 3606 is able to view plaintext data 3604. When received by receiver 3606, encrypted data 3612 is decrypted using the private key 3608 and a decryption algorithm 3614. The receiver 3606 may now view plaintext data 3604.

Symmetric key encryption is much faster than public key encryption, often by a factor of 100 to 1,000. Because public key encryption places a much heavier computational load on computer processors than symmetric key encryption, symmetric key technology is generally used to provide secrecy for the bulk encryption and decryption of information.

Symmetric keys are commonly used by security protocols as session keys for confidential online communications. For example, the Transport Layer Security (TLS) and Internet Protocol security (IPSec) protocols use symmetric session keys with standard encryption algorithms to encrypt and decrypt confidential communications between parties. Different session keys are used for each confidential communication session and session keys are sometimes renewed at specified intervals.

Symmetric keys also are commonly used by technologies that provide bulk encryption of persistent data, such as e-mail messages and document files. For example, Secure/Multipurpose Internet Mail Extensions (S/MIME) uses symmetric keys to encrypt messages for confidential mail, and Encrypting File System (EFS) uses symmetric keys to encrypt files for confidentiality.

In contrast to symmetric key encryption, asymmetric algorithms use the different keys for encrypting and decrypting information. A public asymmetric key is used by a sender to encrypt information and a corresponding private asymmetric key is kept as a secret by the receiver and is used to decrypt information encrypted by the asymmetric public key. The encryption and decryption algorithms are typically not a secret and thus the private symmetric key must be kept secret in order to protect the information. A user's public key can be published in a directory so that it is accessible to other people without comprising security. The two keys are different but mathematically linked in function. Information that is encrypted with the public key can be decrypted only with the corresponding private key of the set. Neither key can perform both functions by itself.

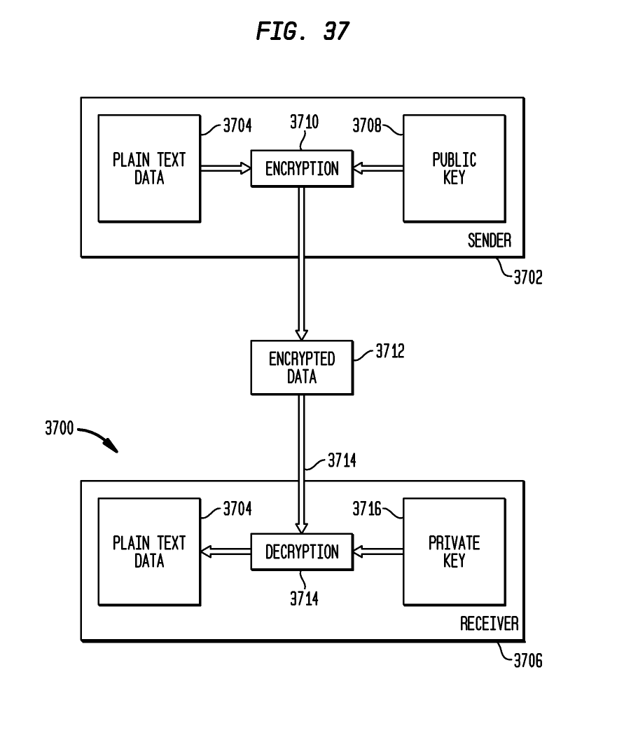

FIG. 37 shows a block diagram of an asymmetric public key system 3700, in accordance with an exemplary embodiment. The public key system 3700 allows a sender 3702 to send plaintext data 3704 to a receiver 3706 with the knowledge that if intercepted, no one other than the receiver can view plaintext data 3704. The sender 3702 encrypts the plaintext data 3704 using a public key 3708 that is publically known. The public key 3708 is typically provided by the receiver 3706. The public key 3708 is used with an encryption algorithm 3710 to securely encrypt plaintext data 3704 into encrypted data 3712. The encryption algorithm 3710 is typically not a secret. Plaintext data 3704 may be text, such as an electronic mail message (e-mail), or any other digital information such as a photograph, or simple binary data. Once encrypted, encrypted data 3712 may be sent on a network 3714, such as the Internet or any other communication link, with confidence that only receiver 3706 is able to view plaintext data 3704. When received by receiver 3706, encrypted data 3712 is decrypted using a private key 3716 and a decryption algorithm 3714. The receiver 3706 may now view plaintext data 3704.

The encryption method known as the RSA digital signature process also uses private keys to encrypt information to form digital signatures. For RSA digital signatures, only the public key can decrypt information encrypted by the corresponding private key of the set. Such a process may be used to verify the authenticity of another party or device.

Today, public key encryption plays an increasingly important role in providing strong, scalable security on intranets and the Internet. Public key encryption is commonly used to perform the following functions, for example: encrypting symmetric keys to protect the symmetric keys during exchange over the network or while being used, stored, or cached by operating systems; creating digital signatures to provide authentication and nonrepudiation for online entities; and creating digital signatures to provide data integrity for electronic files and documents.

Public key encryption is most effective when one side of the transfer is inaccessible. For example, the generation of public keys is fully protected if this generation is performed on a secure internet site (not including site attacks). If asymmetric encryption is utilized for independent point to point communication, then the public and private key generation algorithms reside in silicon that can be de-layered and reversed. This allows duplicate devices to be developed and the data transmitted decrypted.

Known asymmetric and symmetric encryption algorithms can be broken by sufficiently powerful super computers allowing the generation of public and private keys. This is why these algorithms are increasing in complexity. In addition, the transmission of public and private keys may need additional protection from attack, such as dynamic power or electromagnetic emission analysis, in order to protect the data transaction.

In accordance with one aspect of the present invention, an IBG device may be used to protect secure transmission of information from one entity to another, including the encryption and decryption algorithms. The circuitry which performs the algorithms may comprise IBG devices, thus preventing the reverse engineering of the details of the algorithms. In such an IBG based device, maintaining the secrecy of one or more encryption keys is unnecessary since the algorithm is secret. Additionally, dynamic power and electromagnetic attacks would not be successful against an IBG based security system. With IBG based security systems, the importance of asymmetric encryption is reduced and symmetric encryption can now be utilized in low cost applications requiring security.

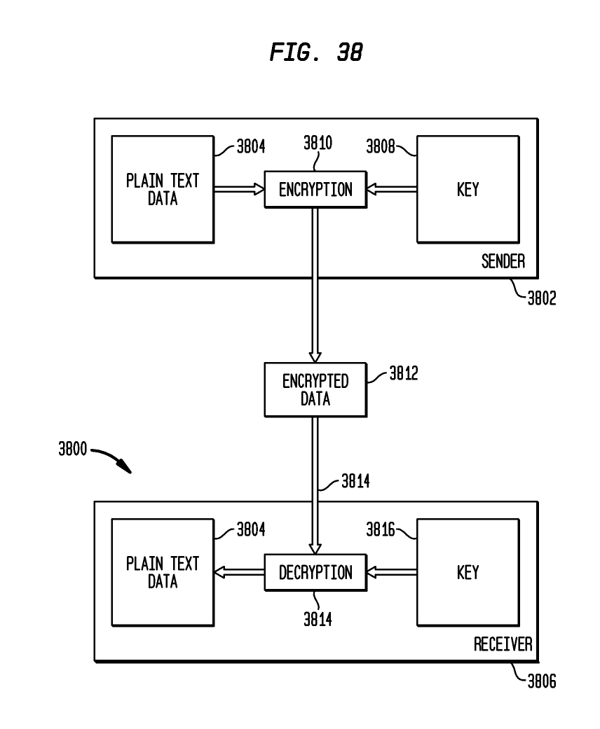

FIG. 38 shows a block diagram of an IBG protected security system 3800 in accordance with the present invention. The IBG protected security system 3800 allows a sender 3802 to send plaintext data 3804 to a receiver 3806 with the knowledge that if intercepted, no one other than the receiver can view plaintext data 3804. The sender 3802 encrypts the plaintext data 3804 using a key 3808. Advantageously, the key 3808 may be publically known or private. The key 3808 is used with an encryption algorithm 3810 to securely encrypt plaintext data 3804 into encrypted data 3812. The encryption algorithm 3810 is a private algorithm that at least partially comprises IBG circuitry which allows the encryption algorithm to be protected from reverse engineering and remain a secret. Plaintext data 3804 may be text, such as an electronic mail message (e-mail), or any other digital information such as a photograph, video, or simple binary data. Once encrypted, encrypted data 3812 may be sent on a network 3814, such as the Internet or any other communication link, with confidence that only receiver 3806 is able to view plaintext data 3804. When received by receiver 3806, encrypted data 3812 is decrypted using a key 3816 and a decryption algorithm 3814. The receiver 3806 may now view plaintext data 3804. The encryption algorithm 3814 at least partially comprises IBG circuitry which allows the encryption algorithm to be protected from reverse engineering and remain a secret. In a preferred embodiment, the encryption and decryption scheme is symmetric and thus the key 3816 used for decryption is the same as the key 3808 used for encryption. In an alternative embodiment, the encryption and decryption is asymmetric and the key 3816 used for decryption is a different from the key 3808 used for encryption. Advantageously, the key 3816 may be publically known or private. IBG circuits may also be used to construct other portions of these systems. For example, IBG ROM may be used to securely store data used by the encryption and decryption systems.

IBG protected encryption and decryption devices may be employed in a variety of systems. For example, FIG. 39 shows a system 3900 for the secure transmission of video in accordance with the present invention. The secure video system 3900 may be used for the transmission of video by a cable TV or satellite TV provider, for example. A video transmission chip 3902 encrypts a stream of video data and then using a medium, such as satellite or cable, transmits the video stream to a video reception chip 3904 which may be located in a user's set top box, for example. The transmission video chip 3902 may comprise encryption circuitry which is implemented using IBG circuitry. Similarly, the video reception video chip 3904 may comprise decryption circuitry which is also implemented using IBG circuitry. While the encryption/decryption scheme may be asymmetric, in a preferred embodiment the encryption and decryption scheme is symmetric, resulting in a reduced computational load to perform the encryption and decryption.

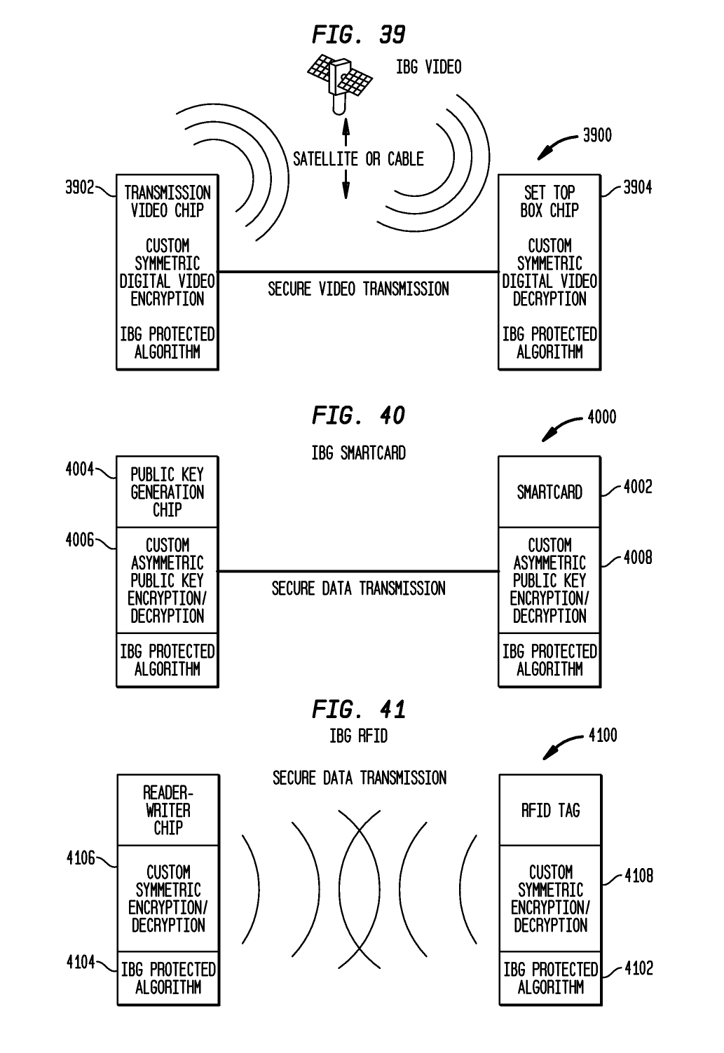

As another example, FIG. 40 shows a block diagram of system 4000 for an IBG protected smart card 4002 and IBG protected smart card reader 4004 which transmits encrypted data to and receives encrypted data from the smart card 4002. Smart cards are typically pocket-sized cards with embedded electronic circuits, but may be embodied in a plurality of forms. Smart card 4002 can provide identification, authentication, data storage, application processing, and other functions, for example. In a preferred embodiment, the smart card reader 4004 includes an asymmetric public key encryption and decryption circuitry 4006 which is implemented using IBG circuitry. The smart card 4002 includes asymmetric public key encryption and decryption circuitry 4008 which is implemented using IBG circuitry. Other portions of circuitry of the smart card 4002 and smart card reader 4004 may also be implemented using IBG circuitry, such as ROM for example. Such an IBG protected smart card circuit may be used in passports, ID cards, and drivers licenses, for example.

FIG. 41 shows a block diagram of system 4100 for an IBG protected RFID tag 4102 and IBG protected RFID reader/writer 4104 which transmits encrypted radio frequency data to and receives encrypted radio frequency data from the RFID tag 4102. In a preferred embodiment, the smart card reader/writer 4104 includes a symmetric public key encryption and decryption circuitry 4106 which is implemented using IBG circuitry. The RFID tag 4102 includes symmetric public key encryption and decryption circuitry 4108 which is implemented using IBG circuitry. Other portions of circuitry of the smart tag 4102 and reader/writer 4004 may also be implemented using IBG circuitry, such as ROM for example. Such an RFID tag may be used for product information, transit fee transactions, such as toll roads, and other environments where secure transactions or authentication are desired.

As described above with respect to FIGS. 25 and 26, circuitry components of an imaging cartridge chip, such as the controller 2504, the memory 2506, the I/O interface circuitry 2502 and any other circuits may be implemented using one or more IBG devices described in detail herein to protect the operation of the circuit from reverse engineering. In one aspect of the present invention an imaging cartridge chip attached to an imaging cartridge may include encryption or decryption circuitry implemented using IBG circuitry. An imaging device, such as a printer, compatible with that imaging cartridge may also include encryption or decryption circuitry implemented using IBG circuitry. When the imaging cartridge is installed in the imaging device, the imaging chip and the imaging device can communicate securely, allowing information to be exchanged and for the imaging device to verify the authenticity of the imaging cartridge.

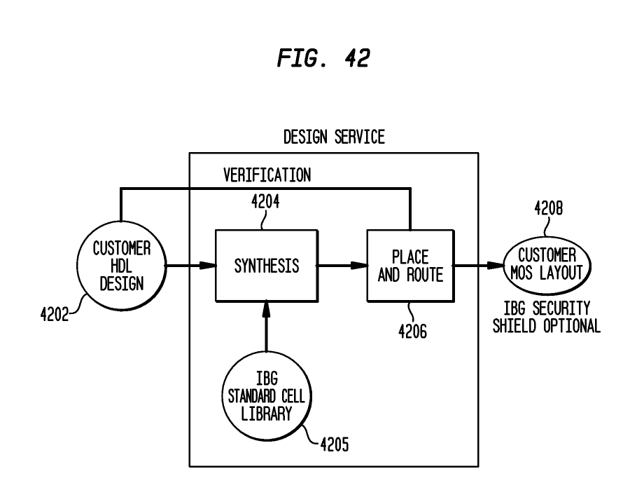

FIG. 42 shows a flow diagram of an exemplary method of incorporating IBG circuitry into an integrated circuit. In a first step 4202 a customer or client provides a high-level design (HDL) description of the function of the integrated circuit. In one aspect of the present invention, the HDL includes a custom encryption and/or decryption circuit. In a second step 4204, the HDL design undergoes a synthesis process which generates a transistor level design description. Portions of an IBG standard cell library 4205 may be incorporated into this design description of protect all or part of the design. The IBG standard cell library may include devices such as logic gates, buffers and memory, for example, which are implemented using IBG circuitry. After this transistor level design has been placed and routed in step 4206, the customer would verify the operation the design. The verified design may then be fabricated by the customer in step 4208.

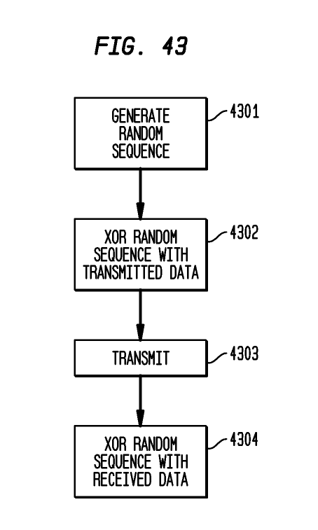

FIG. 43 illustrates using a configurable encryption/decryption engine. In this example, the hardware encryption/decryption engine consists of a 32 bit linear feedback shift register (LFSR) that generates a 32 bit random sequence 4301. The 32 bit random sequence is initialized and exclusive ORed with the transmitted data in the encryption phase 4302 and transmitted to a receiver 4303. It is in turn, initialized and exclusive ORed with the received data in the decryption phase 4304. The Encryption/Decryption Key consists of two 32 bit fields, a 32 bit initialization value and a 32 bit LFSR exclusive OR value used during the shift operation. This 64 bit key creates a unique random sequence and can be implemented internally in IBG form.

The LFSR is configured by 160 IBG cells which effectively scramble the data bits. This scrambling applies to 32 bits of the 64 bit key. If further scrambling is desired, another 160 IBG cells could be used to scramble the remaining 32 bits of the key. Below is an example of hardware descriptive language (HDL) for this encryption/decryption engine.

The following Verilog code defines the hardware encryption/decryption engine.

The above is an example of a 32 bit encryption/decryption engine that is secured using IBG structure. It can be appreciated that encryption/decryption engine can be any desired length. For example, for a basic application were cost is vital, a shorter encryption/decryption, such as an 8 bit encryption/decryption engine can be used. Conversely, in applications where security is more vital, longer encryption/decryption engines can be used, such as a 128 bit encryption/decryption engine. The encryption/decryption engine can be selected to balance the cost, size, and security of the device.

The many features and advantages of the invention are apparent from the detailed specification. Thus, the appended claims are intended to cover all such features and advantages of the invention which fall within the true spirits and scope of the invention. Further, since numerous modifications and variations will readily occur to those skilled in the art, it is not desired to limit the invention to the exact construction and operation illustrated and described. Accordingly, all appropriate modifications and equivalents may be included within the scope of the invention.

Although this invention has been illustrated by reference to specific embodiments, it will be apparent to those skilled in the art that various changes and modifications may be made which clearly fall within the scope of the invention. The invention is intended to be protected broadly within the spirit and scope of the appended claims.

What is claimed is:

1. A digital security system comprising:
an encryption circuit for receiving an input of a first digital key and plaintext data, the encryption circuit for mathematically manipulating the digital key and the plaintext data to encrypt the plaintext data into encrypted data,
wherein at least a portion of the encryption circuit comprises means for IBG circuitry.

2. The digital security system of claim 1 further comprising:
a decryption circuit for receiving an input of a second digital key and the encrypted data, the decryption circuit for mathematically manipulating the digital key and the encrypted data to decrypt the encrypted data into the plaintext data,
wherein at least a portion of the decryption circuit comprises means for IBG circuitry.

3. The digital security system of claim 2 wherein the first digital key equals the second digital key.

4. The digital security system of claim 3 wherein at least one of the first digital key and the second digital key is a public key.

5. The digital security system of claim 1 wherein the encryption circuit is adapted for forming a digital signature.

6. The digital security system of claim 1 wherein the encryption circuit comprises a private algorithm.

7. The digital security system of claim 2 wherein the decryption circuit comprises a private algorithm.

8. The digital security system of claim 2 wherein the first digital key does not equal the second digital key.

9. The digital security system of claim 8 wherein at least one of the first digital key and the second digital key is a public key.

10. The digital security system of claim 9 wherein the encryption circuit comprises a private algorithm.

11. The digital security system of claim 2 wherein at least one of the encryption circuit and the decryption circuit is disposed in an imaging cartridge chip.

12. The digital security system of claim 2 wherein at least one of the encryption circuit and the decryption circuit is disposed in an imaging device.

13. A digital security system comprising:
a decryption circuit for receiving an input of a digital key and encrypted data, the decryption circuit for mathematically manipulating the digital key and the encrypted data to decrypt the plaintext data into plaintext data,
wherein at least a portion of the decryption circuit comprise means for IBG circuitry.

14. The digital security system of claim 13 wherein the decryption circuit is disposed in an imaging cartridge chip.

15. The digital security system of claim 13 wherein the decryption circuit is disposed in an imaging device.

16. The digital security system of claim 13 wherein the decryption circuit comprises a private algorithm.

17. A method of forming a digital security circuit comprising:
designing an encryption algorithm; and
forming an integrated circuit comprising devices to perform the encryption algorithm,
wherein at least a portion the devices comprise means for IBG circuitry.

18. The method of claim 17 wherein the encryption algorithm is a private algorithm.

19. A method of forming a digital security circuit comprising:
designing an decryption algorithm; and
forming an integrated circuit comprising devices to perform the decryption algorithm,
wherein at least a portion the devices comprise means for IBG circuitry.

20. The method of claim 19 wherein the encryption algorithm is a private algorithm.
